(19) United States
(12) Patent Application Publication
(10) Pub. No.: US 2016/0004355 A1
(43) Pub. Date: Jan. 7, 2016

(54) ACTUATING USER INTERFACE FOR MEDIA PLAYER

(71) Applicant: Apple Inc., Cupertino, CA (US)

(72) Inventors: Stephen Paul ZADESKY, Portola Valley, CA (US); Jonathan P. IVE, San Francisco, CA (US); Christopher J. STRINGER, Woodside, CA (US); Matthew Dean ROHRBACH, San Francisco, CA (US); Stephen Brian LYNCH, Portola Valley, CA (US); Brett William DEGNER, Menlo Park, CA (US)

(21) Appl. No.: 14/850,901

(22) Filed: Sep. 10, 2015

Related U.S. Application Data
(63) Continuation of application No. 14/527,585, filed on Oct. 29, 2014.
Application No. 14/527,585 is a continuation of application No. 11/477,469, filed on Jun. 28, 2006.
Application No. 11/477,469 is a continuation of application No. 11/057,050, filed on Feb. 11, 2005.
Application No. 11/057,050 is a continuation-in-part of application No. 10/643,256, filed on Aug. 18, 2003, now Pat. No. 7,499,040.

(51) Int. Cl. G06F 3/044; G06F 3/0338; G06F 3/0488; G06F 3/041; G06F 3/0481; G06F 3/0484; G06F 3/02; G06F 3/0354

(52) U.S. Cl. CPC G06F 3/044; G06F 3/0227; G06F 3/0338; G06F 3/03547; G06F 3/03548; G06F 3/0414; G06F 3/04812; G06F 3/04842; G06F 3/0488; G06F 2203/04105; G06F 2203/04108; G06F 2203/04806

(57) ABSTRACT

An actuating user interface for a media player or other electronic device is disclosed. According to one aspect, the user interface is a display device that can both display visual information and serve as a mechanical actuator to generate input signals is disclosed. The display device, which displays visual information such as text, characters and graphics, may also act like a push or clickable button(s), a sliding toggle button or switch, a rotating dial or knob, a motion controlling device such as a joystick or navigation pad, and/or the like. According to another aspect, the user interface is an input device that includes a movable touch pad control signal capable of detecting the movements of the movable touch pad so as to generate one or more distinct second control signals. The control signals being used to perform actions in an electronic device operatively coupled to the input device.

### CROSS-REFERENCE TO RELATED APPLICATIONS

This application is a continuation of U.S. patent application Ser. No. 14/527,585, filed Oct. 29, 2014, which is a continuation of U.S. patent application Ser. No. 11/477,469, filed Jun. 28, 2006, which is a continuation of U.S. patent application Ser. No. 11/057,050, filed Feb. 11, 2005, and a continuation-in-part of U.S. patent application Ser. No. 10/643,256, filed Aug. 18, 2003, now U.S. Patent No. 7,499,040, the entire contents of which are incorporated herein by reference.

In addition, this application is related to the following applications, which are all herein incorporated by reference:

U.S. patent application Ser. No. 10/840,862, titled “MULTIPOINT TOUCHSCREEN,” filed May 6, 2004; and U.S. patent application Ser. No. 10/903,964, titled “GESTURES FOR TOUCH SENSITIVE INPUT DEVICES,” filed Jul. 30, 2004.

### BACKGROUND OF THE INVENTION

1. Field of the Invention

The present invention relates generally to electronic devices. More particularly, the present invention relates to an electronic device having an actuating user interface.

2. Description of the Related Art

There exists today many types of consumer electronic devices, each of which utilizes some sort of user interface. The user interface typically includes an output device in the form of a fixed display, such as an Liquid Crystal Display (LCD), and one or more input devices. The input devices can be mechanically actuated as for example, switches, buttons, keys, dials, joysticks, navigation pads, or electrically activated as for example touch pads and touch screens. The display is typically configured to present visual information such as text and graphics, and the input devices are typically configured perform operations such as issuing commands, making selections or moving a cursor or selector in the consumer electronic device. Each of these well known devices has considerations such as size and shape limitations, costs, functionality, complexity, etc. that must be taken into account when designing the consumer electronic device. In most cases, the user interface is positioned on the front face of the electronic device for easy viewing of the display and easy manipulation of the input devices.

FIGS. 1A-1F are diagrams of various handheld electronic devices including for example a telephone 10A (FIG. 1A), a PDA 10B (FIG. 1B), a media player 10C (FIG. 1C), a remote control 10D (FIG. 1D), a camera 10E (FIG. 1E), and a GPS module 10F (FIG. 1F). FIGS. 1G-1I, on the other hand, are diagrams of other types of electronic devices including for example a laptop computer 10G (FIG. 1G), a stereo 10H (FIG. 1H), and a fax machine 10I (FIG. 1I). In each of these devices 10, a display 12 is secured inside the housing of the device 10. The display 12 can be seen through an opening in the housing, and is typically positioned in a first region of the electronic device 10. One or more input devices 14 are typically positioned in a second region of the electronic device 10 next to the display 12 (excluding touch screens, which are positioned over the display).

To elaborate, the telephone 10A typically includes a display 12 such as a character or graphical display, and input devices 14 such as a number pad and in some cases a navigation pad. The PDA 10B typically includes a display 12 such as a graphical display, and input devices 14 such as a touch screen and buttons. The media player 10C typically includes a display 12 such as a character or graphic display, and input devices 14 such as buttons or wheels. The iPod® brand media player manufactured by Apple Computer, Inc. of Cupertino, Calif. is one example of a media player that includes both a display and input devices disposed next to the display. The remote control 10D typically includes an input device 14 such as a keypad and may or may not have a character display 12. The camera 10E typically includes a display 12 such as a graphic display and input devices 14 such as buttons. The GPS module 10F typically includes a display 12 such as graphic display and input devices 14 such as buttons, and in some cases a navigation pad. The laptop computer 10G typically includes a display 12 such as a graphic display, and input devices 14 such as a keyboard, a touchpad and in some cases a joystick. The iBook® brand notebook computer manufactured by Apple Computer, Inc. of Cupertino, Calif. is one example of a laptop computer that includes both a display and input devices disposed next to the display (e.g., in a base). The stereo 10H typically includes a display 12 such as a character display, and input devices such as buttons and dials. The fax machine 10I typically includes a display 12 such as a character display, and input devices 14 such as a number pad and one or more buttons.

Although the user interface arrangements described above work well, improved user interface devices, particularly ones that can reduce the amount of real estate required and/or ones that can reduce or eliminate input devices, are desired. By reducing or eliminating the input devices, the display of the electronic device can be maximized within the user interface portion of the electronic device, or alternatively the electronic device can be minimized to the size of the display.

There also exists today many styles of input devices for performing operations on consumer electronic devices. The operations generally correspond to moving a cursor and making selections on a display screen. By way of example, the input devices may include buttons, switches, keyboards, mice, trackballs, touch pads, joy sticks, touch screens and the like. Each of these input devices has advantages and disadvantages that are taken into account when designing the consumer electronic device. In handheld computing devices, the input devices are generally selected from buttons and switches. Buttons and switches are generally mechanical in nature and provide limited control with regards to the movement of a cursor (or other selector) and making selections. For example, they are generally dedicated to moving the cursor in a specific direction (e.g., arrow keys) or to making specific selections (e.g., enter, delete, number, etc.). In the case of hand-held personal digital assistants (PDA), the input devices tend to utilize touch-sensitive display screens. When using a touch screen, a user makes a selection on the display screen by pointing directly to objects on the screen using a stylus or finger.

In portable computing devices such as laptop computers, the input devices are commonly touch pads. With a touch pad, the movement of an input pointer (i.e., cursor) corresponds to the relative movements of the user's finger (or stylus) as the finger is moved along a surface of the touch pad. Touch pads can also make a selection on the display screen when one or more taps are detected on the surface of the touch pad. In some cases, any portion of the touch pad may be tapped, and in other cases a dedicated portion of the touch pad may be tapped. In stationary devices such as desktop computers, the input devices are generally selected from mice and trackballs. With a mouse, the movement of the input pointer corresponds to the relative movements of the mouse as the user moves the mouse along a surface. With a trackball, the movement of the input pointer corresponds to the relative movements of a ball as the user rotates the ball within a housing. Both mice and trackballs generally include one or more buttons for making selections on the display screen.

In addition to allowing input pointer movements and selections with respect to a GUI presented on a display screen, the input devices may also allow a user to scroll across the display screen in the horizontal or vertical directions. For example, mice may include a scroll wheel that allows a user to simply roll the scroll wheel forward or backward to perform a scroll action. In addition, touch pads may provide dedicated active areas that implement scrolling when the user passes his or her finger linearly across the active area in the x and y directions. Both devices may also implement scrolling via horizontal and vertical scroll bars as part of the GUI. Using this technique, scrolling is implemented by positioning the input pointer over the desired scroll bar, selecting the desired scroll bar, and moving the scroll bar by moving the mouse or finger in the y direction (forwards and backwards) for vertical scrolling or in the x direction (left and right) for horizontal scrolling.

With regards to touch pads, mice and track balls, a Cartesian coordinate system is used to monitor the position of the finger, mouse and ball, respectively, as they are moved. The Cartesian coordinate system is generally defined as a two dimensional coordinate system (x, y) in which the coordinates of a point (e.g., position of finger, mouse or ball) are its distances from two intersecting, often perpendicular straight lines, the distance from each being measured along a straight line parallel to each other. For example, the x, y positions of the mouse, ball and finger may be monitored. The x, y positions are then used to correspondingly locate and move the input pointer on the display screen.

To elaborate further, touch pads generally include one or more sensors for detecting the proximity of the finger thereto. By way of example, the sensors may be based on resistive sensing, surface acoustic wave sensing, pressure sensing, optical sensing, capacitive sensing and the like. The sensors are generally dispersed about the touch pad with each sensor representing an x, y position. In most cases, the sensors are arranged in a grid of columns and rows. Distinct x and y position signals, which control the x, y movement of a pointer device on the display screen, are thus generated when a finger is moved across the grid of sensors within the touch pad. For brevity sake, the remaining discussion will be held to the discussion of capacitive sensing technologies. It should be noted, however, that the other technologies have similar features.

Capacitive sensing touch pads generally contain several layers of material. For example, the touch pad may include a protective shield, one or more electrode layers and a circuit board. The protective shield typically covers the electrode layer(s), and the electrode layer(s) is generally disposed on a front side of the circuit board. As is generally well known, the protective shield is the part of the touch pad that is touched by the user to implement cursor movements on a display screen. The electrode layer(s), on the other hand, is used to interpret the x, y position of the user's finger when the user's finger is resting or moving on the protective shield. The electrode layer (s) typically consists of a plurality of electrodes that are positioned in columns and rows so as to form a grid array. The columns and rows are generally based on the Cartesian coordinate system and thus the rows and columns correspond to the x and y directions.

The touch pad may also include sensing electronics for detecting signals associated with the electrodes. For example, the sensing electronics may be adapted to detect the change in capacitance at each of the electrodes as the finger passes over the grid. The sensing electronics are generally located on the backside of the circuit board. By way of example, the sensing electronics may include an application specific integrated circuit (ASIC) that is configured to measure the amount of capacitance in each of the electrodes and to compute the position of finger movement based on the capacitance in each of the electrodes. The ASIC may also be configured to report this information to the computing device.

Referring to FIG. 1J, a touch pad 20 will be described in greater detail. The touch pad is generally a small rectangular area that includes a protective shield 22 and a plurality of electrodes 24 disposed underneath the protective shield layer 22. For ease of discussion, a portion of the protective shield layer 22 has been removed to show the electrodes 24. Each of the electrodes 24 represents a different x, y position. In one configuration, as a finger 26 approaches the electrode grid 24, a tiny capacitance forms between the finger 26 and the electrodes 24 proximate the finger 26. The circuit board/sensing electronics measures capacitance and produces an x, y input signal 28 corresponding to the active electrodes 24 is sent to a host device 30 having a display screen 32. The x, y input signal 28 is used to control the movement of a cursor 34 on a display screen 32. As shown, the input pointer moves in a similar x, y direction as the detected x, y finger motion. Thus, there is a continuing need for improved user interfaces for electronic devices.

### SUMMARY OF THE INVENTION

The invention relates to an actuating user interface for a media player or other electronic device. According to a first aspect, the invention relates, in one embodiment, to an integral input/output device. The integral input/output device includes a display that moves relative to a frame or housing. The integral input/output device also includes a movement detection mechanism configured to generate signals when the display is moved. The signals are indicative of at least one predetermined movement of the display. The invention relates, in another embodiment, to an electronic device. The electronic device includes a housing. The electronic device also includes a movable display apparatus constrained within the housing, wherein physically moving the movable display apparatus within the housing operates to signal at least one user input.

According to a second aspect, the invention relates, in one embodiment, to an input device. The input device, in one embodiment, includes a touch pad capable of detecting an object in close proximity thereto. More particularly, the invention relates to a touch pad capable of moving in order to increase the functionality of the touch pad. For example, the touch pad may be depressible so as to provide additional button functionality. In one embodiment, the input device includes a movable touch pad configured to generate a first control signal when the movable touchpad is moved and a second control signal when an object is positioned over the movable touchpad.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A-1I are diagrams of various electronic devices.

FIG. 1J is a simplified diagram of a touch pad and display.

FIG. 2 is a side elevation view, in cross section, of a display actuator, in accordance with one embodiment of the present invention.

FIGS. 3A and 3B are side elevation views, in cross section, of a push display button, in accordance with one embodiment of the present invention.

FIGS. 4A and 4B are side elevation views, in cross section, of a sliding display switch, in accordance with one embodiment of the present invention.

FIGS. 5A-5C are side elevation views, in cross section, of a clickable display button, in accordance with one embodiment of the present invention.

FIGS. 6A and 6B are side elevation views, in cross section, of a display dial, in accordance with one embodiment of the present invention.

FIGS. 7A and 7B, are side elevation views, in cross section, of a display actuator with a touch screen, in accordance with one embodiment of the present invention.

FIG. 8 is a simplified perspective diagram of an electronic device, in accordance with one embodiment of the present invention.

FIG. 9 is a side elevation view, in cross section, of an electronic device, in accordance with one embodiment of the present invention.

FIGS. 10A-10D are side elevation views, in cross section, of the electronic device shown in FIG. 9, in accordance with one embodiment of the present invention.

FIGS. 11A and 11B are side elevation views, in cross section, of an electronic device, in accordance with an alternate embodiment of the present invention.

FIG. 12 is diagram of an electronic device, in accordance with an alternate embodiment of the present invention.

FIG. 13 is a diagram of an electronic device, in accordance with an alternate embodiment of the present invention.

FIG. 14 is a perspective diagram of an electronic device, in accordance with one embodiment of the present invention.

FIG. 15A is a side elevation view, in cross section, of an electronic device, in accordance with one embodiment of the present invention.

FIG. 15B is a top view, in cross section, of the electronic device shown in FIG. 15A, in accordance with one embodiment of the present invention.

FIGS. 16A and 16B are side elevation views, in cross section, of the electronic device shown in FIG. 15A, in accordance with one embodiment of the present invention.

FIG. 17 is a diagram of an electronic device, in accordance with an alternate embodiment of the present invention.

FIG. 18 is a block diagram of an electronic device, in accordance with one embodiment of the present invention.

FIG. 19 is a perspective view of an input device, in accordance with one embodiment of the present invention.

FIG. 20A and 20B are simplified side views of an input device having a button touch pad, in accordance with one embodiment of the present invention.

FIG. 21 is simplified block diagram of an input device connected to a computing device, in accordance with one embodiment of the present invention.

FIG. 22 is a simplified perspective diagram of an input device, in accordance with one embodiment of the present invention.

FIG. 23 is a side elevation view of a multi button zone touch pad, in accordance with one embodiment of the present invention.

FIGS. 24A-24D show the touch pad of FIG. 23 in use, in accordance with one embodiment of the present invention.

FIG. 25 is a perspective diagram of an input device, in accordance with one embodiment of the present invention.

FIG. 26 is an exploded perspective diagram of an input device, in accordance with one embodiment of the present invention.

FIG. 27 is a side elevation, in cross section, of an input device, in accordance with one embodiment of the present invention.

FIG. 28 is a side elevation, in cross section, of an input device, in accordance with one embodiment of the present invention.

FIG. 29 is a perspective diagram of a touch pad having switches on its backside, in accordance with one embodiment of the present invention.

FIG. 30 is a perspective diagram of a media player, in accordance with one embodiment of the present invention.

FIG. 31 is a perspective diagram of a laptop computer, in accordance with one embodiment of the present invention.

FIG. 32 is a perspective diagram of a desktop computer with a peripheral input device connected thereto, in accordance with one embodiment of the present invention.

FIG. 33 is a perspective diagram of a remote control utilizing an input device, in accordance with one embodiment of the present invention.

FIG. 34 is an exploded perspective diagram of a media player and input device assembly, in accordance with one embodiment of the present invention.

FIG. 35 is a side elevation view of the bottom side of a media player containing an input device, in accordance with one embodiment of the present invention.

FIG. 36 is a simplified block diagram of a remote control, in accordance with one embodiment of the present invention.

FIGS. 37A and 37B are side elevation views, in cross section of an input device, in accordance with an alternate embodiment of the present invention.

### DETAILED DESCRIPTION OF THE INVENTION

According to a first aspect, the invention relates to a display apparatus that both displays visual information and serves as a mechanical actuator to generate input signals. That is, the display apparatus is not only an output device, but also a mechanically actuated input device. Accordingly, in one embodiment, the display apparatus can be referred to as a display actuator. By way of example, the display apparatus, which displays visual information such as text, characters and/or graphics, may also act like a push or clickable button(s), a sliding toggle button or switch, a rotating dial or knob, a motion controlling device (such as a joystick or navigation pad), and/or the like. The display apparatus may be incorporated into any electronic device to control various aspects of the electronic device. Alternatively, the display apparatus may be a stand alone device that operatively couples to an electronic device through wired or wireless connections. For example, the display apparatus may be a peripheral input/output device that connects to a personal computer. In either case, the display apparatus can be configured to generate commands, make selections and/or control movements in a display.

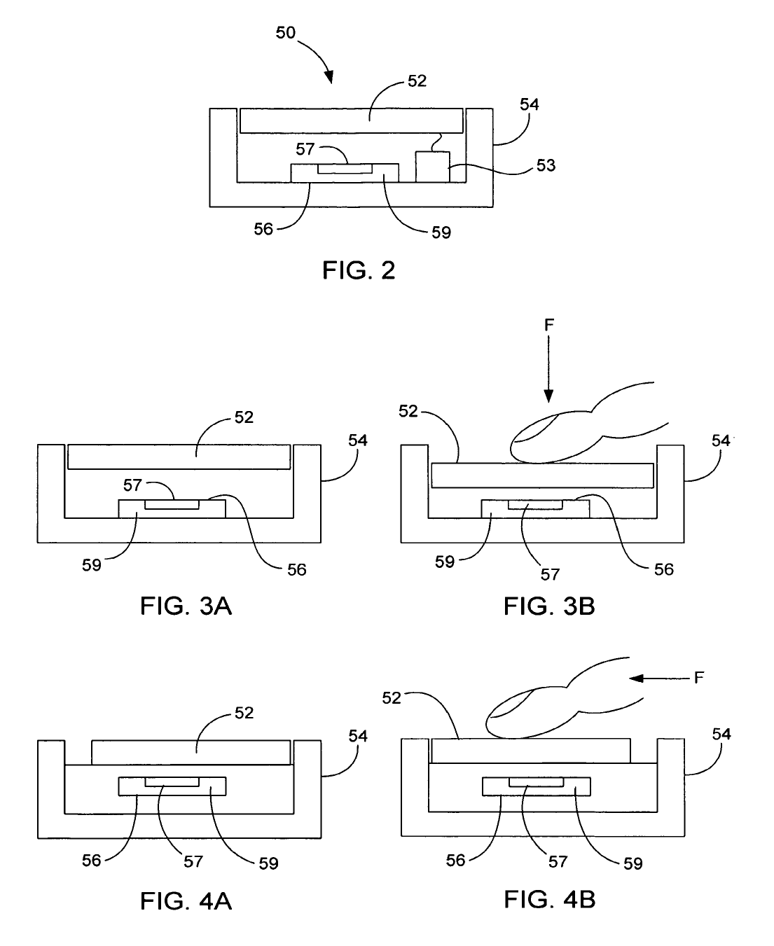

Embodiments of the first aspect of the invention are discussed below with reference to FIGS. 2-18. However, those skilled in the art will readily appreciate that the detailed description given herein with respect to these figures is for explanatory purposes as the invention extends beyond these limited embodiments.

FIG. 2 is a display actuator 50, in accordance with one embodiment of the present invention. The display actuator 50 includes a movable display 52 that along with presenting visual information, such as text, characters and graphics via display signals from display control circuitry 53, also causes one or more input signals to be generated when moved. The input signals can be used to initiate commands, make selections, or control motion in a display. The display 52 is typically movable relative to a frame or housing 54 that movably supports the display in its various positions. In some cases, the display 52 is movably coupled to the frame 54, and in other cases the frame movably restrains a floating display. Furthermore, the input signals are typically generated by a detection mechanism 56 that monitors the movements of the display 52 and produces signals indicative of such movements.

The display 52, which again is configured to display text, characters and/or graphics via one or more display signals, is typically selected from flat panel devices although this is not a requirement and other types of displays may be utilized. Flat panel devices typically provide a rigid planar platform, which is robust and which makes for easy manipulation thereof. By way of example, the display 52 may correspond to a liquid crystal display (LCD) such as character LCDs that are capable of presenting text and symbols or graphical LCDs that are capable of presenting images, video, and graphical user interfaces (GUI). Alternatively, the display 52 may correspond to a display based on organic light emitting diodes (OLED), or a display that is based on electronic inks. More alternatively, the display may be based on plasma and DLP technologies.

The movements of the display 52 may be widely varied. For example, the movable display 52 may be configured to translate, slide, pivot, and/or rotate relative to the frame 54. As shown in FIGS. 3A and 3B, the movable display 52 is configured to translate as, for example, in the z-direction, such that the display 52 is depressible (by a force F) in a manner similar to a push button. For example, the display 52 may translate between an upright and a depressed position in order to generate an input signal via the detection mechanism 56.

As shown in FIGS. 4A and 4B, the movable display 52 is configured to slide in for example the x and/or y directions in a manner similar to a sliding switch. By way of example, the display 52 may slide between a first position and a second position in order to generate one or more user inputs via the detection mechanism 56. In some cases, the display 52 may also be configured to slide in the x/y plane thereby covering both the x and y directions as well as diagonals located therebetween.

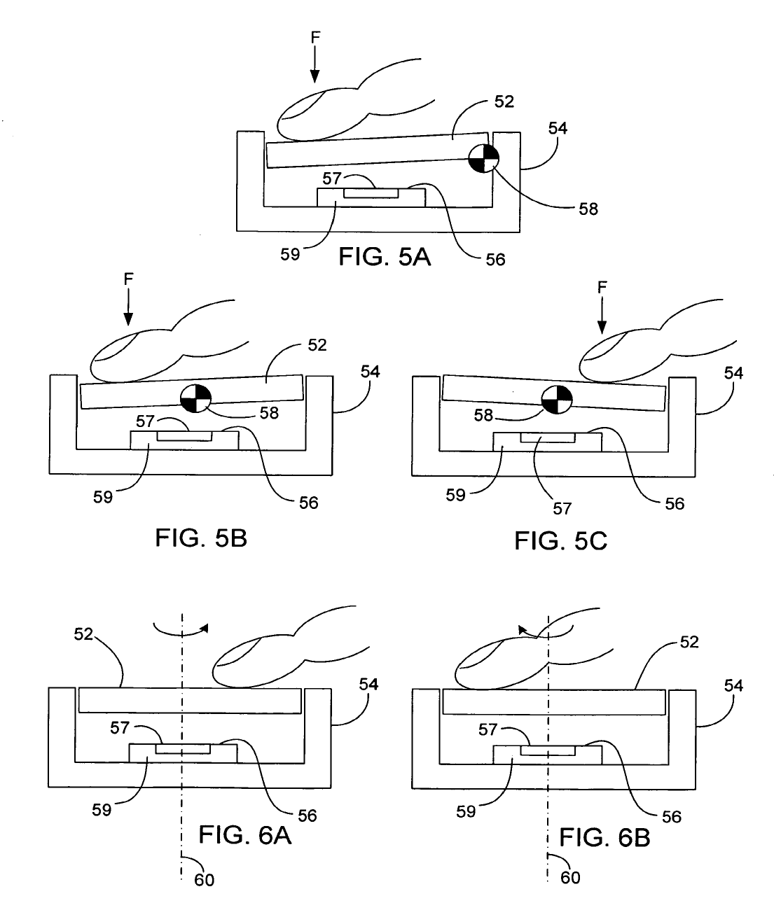

As shown in FIGS. 5A-5C, the movable display 52 is configured to pivot around an axis 58. In such embodiments, the display 52 can provide an action similar to a clickable button. The position of the axis 58 may be placed proximate an edge of the display 52 to form a single tilting action (FIG. 5A) or it may be placed towards the center of the display 52 to form multiple tilting actions (FIGS. 5B and 5C). In the first case, a single input is typically generated when the display is tilted while in the later case multiple user inputs may be generated. For example, a first user input may be generated when the display 52 is tilted in the forward direction (FIG. 5B) and a second user input may be generated when the display 52 is tilted in the backward direction (FIG. 5C). Additional axes may also be used to produce even more tilting actions and thus more signals. For example, when a second axis is used, additional signals may be generated when the display 52 is tilted to the right and left sides rather than forward and backward.

As shown in FIGS. 6A and 6B, the display 52 is configured to rotate as for example about the z axis 60 such that the display 52 operates similarly to a dial or wheel. For example, the display 52 may be rotated clockwise or counterclockwise in order to generate various user inputs via the detection mechanism 56.

It should be noted that the invention is not limited to the movements shown in FIGS. 3A-6B, and that other movements are possible including for example a combination of the embodiments shown above. When combined, each of the various actions typically generates its own set of user inputs. Alternatively, combined actions may cooperate to produce a new set of user inputs. By way of example, the tilting action shown in FIGS. 5A-5C may be combined with the sliding action shown in FIGS. 4A and 4B, or the translating action of FIGS. 3A and 3B may be combined with the rotating action of FIGS. 6A and 6B. Any combination of actions may be used including more than two. For example, the translating action of FIGS. 3A and 3B may be combined with the tilting actions and rotating actions of FIGS. 5A-5C, 6A and 6B.

In order to produce the various movements, the display 52 may be coupled to the frame 54 through various axels, pivot joints, slider joints, ball and socket joints, flexure joints, magnetic joints, roller joints, and/or the like. By way of example, and not by way of limitation, an axel may be used in the embodiment shown in FIGS. 6A and 6B, a pivot joint utilizing for example pivot pins or a flexure may be used in the embodiment shown in FIGS. 5A-5C, and a slider joint utilizing for example a channel arrangement may be used in the embodiments shown in FIGS. 3A, 3B, 4A and 4B. The display 52 may additionally be made movable through a combination of joints such as a pivot/sliding joint, pivot/flexure joint, sliding/flexure joint, pivot/pivot joint, in order to increase the range of motion (e.g., increase the degree of freedom).

Furthermore, in order to generate signals indicative of the movements, the detection mechanism 56 generally includes one or more movement indicators 57 such as switches, sensors, encoders, and/or the like as well as input control circuitry 59. In one embodiment, the input control circuitry 59 can be embodied in an integrated circuit chip, such as an ASIC. These devices, which can be directly attached to the frame 54 or indirectly through for example a Printed Circuit Board (PCB). The devices may also be placed underneath the display 52 or at the sides of the display 52 in order to monitor the movements of the display 52. Alternatively or additionally, these devices may be attached to the display 52 or some component of the display 52. The movement indicators 57 may be any combination of switches, sensors, encoders, etc.

Switches are generally configured to provide pulsed or binary data such as activate (on) or deactivate (off). By way of example, an underside portion of the display 52 may be configured to contact or engage (and thus activate) a switch when the user presses on the display 52. Sensors are generally configured to provide continuous or analog data. By way of example, the sensor may be configured to continuously measure the position or the amount of tilt of the display 52 relative to the frame 54 when a user presses on the display 52. Encoders, on the other hand, typically utilize one or more switches or sensors to measure rotation, for example, rotation of the display 52.

Any suitable mechanical, electrical and/or optical switch, sensor or encoder may be used. For example, tact switches, force sensitive resistors, pressure sensors, proximity sensors, infrared sensors, mechanical or optical encoders and/or the like may be used in any of the arrangement described above.

Referring to FIGS. 3A-6B, and by way of example and not limitation, an encoder may be used in the embodiment of FIGS. 6A and 6B, one or more switches may be used in the embodiments shown in FIGS. 3A, 3B, 5A, 5B and 5C, and one or more sensors may be used in the embodiment shown in FIGS. 4A and 4B. It should be noted, however, that these particular arrangements are not a limitation and that other arrangements may be used to monitor the movements in the embodiments shown in FIGS. 3A-6B.

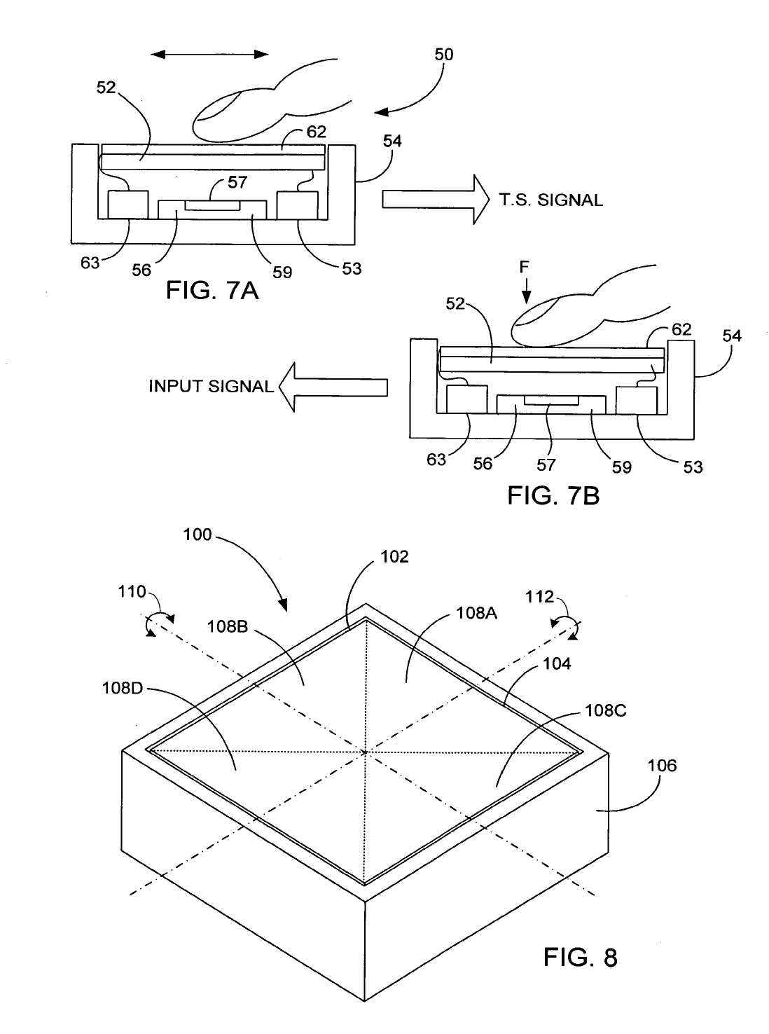

Referring to FIGS. 7A and 7B, a touch screen 62 may be provided along with the movable display 52 to further increase the functionality of the display actuator 50. The touch screen 62 is a transparent panel that is positioned in front of the movable display 52. Unlike the movable display 52, however, the touch screen 62 generates input signals when an object, such as a finger, touches or is moved across the surface of the touch screen 62 (e.g., linearly, radially, rotary, etc.). The touch screen 62 is typically operatively coupled to input control circuitry 63. The input control circuitry 63 can be implemented as an integrated circuit chip, such as an ASIC. In some cases, the input control circuitry 63 can be combined with the input control circuitry 59 of the detection mechanism 56, while in other cases these components can be kept separate.

To elaborate, touch screens allow a user to make selections and/or move a cursor by simply touching the display screen via a finger or stylus. For example, a user may make a selection by pointing directly to a graphical object displayed on the display screen. The graphical object may for example correspond to an on-screen button for performing specific actions in the electronic device. In general, the touch screen recognizes the touch and position of the touch on the display and a controller of the electronic device interprets the touch and thereafter performs an action based on the touch event. There are several types of touch screen technologies including resistive, capacitive, infrared and surface acoustic wave.

In one particular embodiment, the touch screen is a capacitive touch screen that is divided into several independent and spatially distinct sensing points, nodes or regions that are positioned throughout the touch screen. The sensing points, which are typically hidden from view (transparent), are dispersed about the touch screen with each sensing point representing a different position on the surface of the touch screen (or touch screen plane). The sensing points may be positioned in a grid or a pixel array where each pixilated sensing point is capable of generating a signal. In the simplest case, a signal is produced each time an object is positioned over a sensing point. When an object is placed over multiple sensing points or when the object is moved between or over multiple sensing point, multiple signals can be generated. As should be appreciated, the sensing points generally map the touch screen plane into a coordinate system such as a Cartesian coordinate system a Polar coordinate system or some other coordinate system.

As shown in FIG. 7A, the touch screen 62 generates touch screen signals when an object such as a user's finger is moved over the top surface of the touch screen 62 in the x, y plane. As shown in FIG. 7B, when the display 52 is moved (e.g., depressed), the detection mechanism 56 generates one or more input signals. In some cases, the display actuator 50 is arranged to provide both the touch screen signals and the input signals at the same time, i.e., simultaneously moving the display 52 while implementing a touch action on the touch screen 62. In other cases, the display actuator 50 is arranged to only provide an input signal when the display 52 is moved and a touch screen signal when the display 52 is stationary. Furthermore, the display is configured to present visual information during both display movements and finger movements thereon. That is, while the display actuator 50 is reporting inputs from the touch screen and actuator, it is also receiving inputs for controlling the display.

In some cases, the display is configured to display information associated with the actuator portion of the display. For example, it may present information indicating how to use the actuator or what function the actuator will implement when the display is moved. The information is typically only presented in the region of relevance. For example, if a forward tilt produces a menu command, then the display may present a title “MENU” in the location of where the forward tilt is implemented. Alternatively, the display may present selectable icons in the region where the actuator will affect selection of one or more of the icons.

Referring to all the previous Figures, the display actuator 50, which includes both input and output functionality, is typically connected to an electronic device. The display actuator 50 may be a stand alone unit that is operatively coupled to the electronic device through wired or wireless connections. Alternatively, the display actuator 50 may be integrated into the electronic device, i.e., it is a permanent fixture of the electronic device. When a stand alone unit, the display actuator 50 typically has its own enclosure and can be considered a peripheral input device, such as a keyboard or mouse. When integrated with an electronic device, the display actuator 50 typically uses the enclosure of the electronic device and can be considered a permanent fixture of the electronic device.

The electronic device may correspond to any consumer related electronic product. By way of example, the electronic device may correspond to computers such as desktop computers, laptop computers or PDAs, media players such as music players, photo players or video players, communication devices such as telephones, cellular phones or mobile radios, peripheral devices such as keyboards, mice, and printers, cameras such as still cameras and video cameras, GPS modules, remote controls, car displays, audio/visual equipment such as televisions, radios, stereos, office equipment such a fax machines and teleconference modules, and the like.

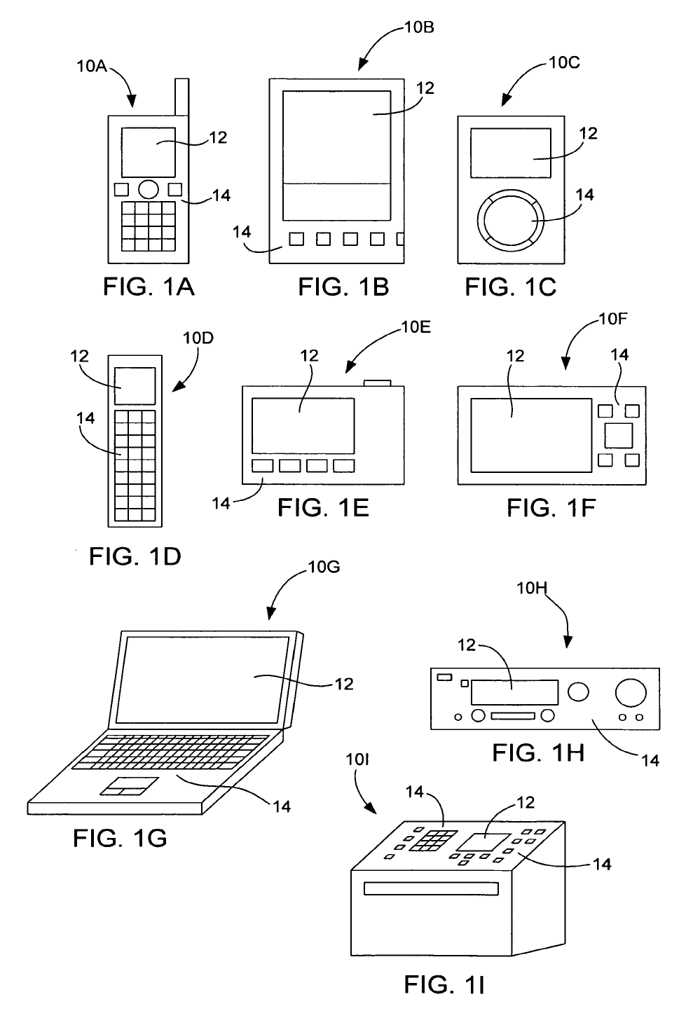

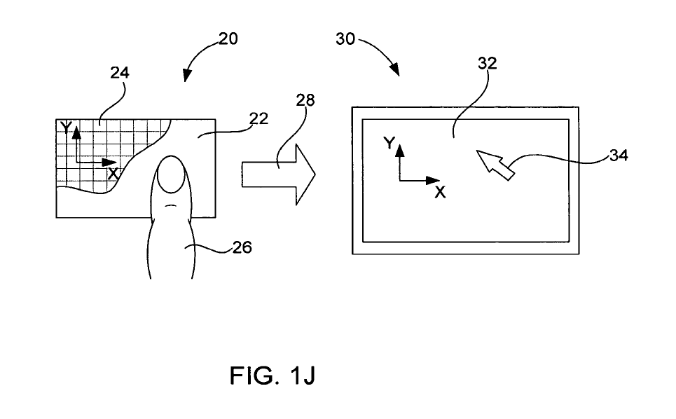

In essence, the display actuator 50 can be integrated with any electronic device that requires an input means such as buttons, switches, keys, dials, wheels, joysticks/pads, etc. In fact, the display actuator 50 can in some instances completely replace all other input means (as well as output) of the electronic device. By way of example, the display and buttons of the media player shown in FIG. 1C can be replaced by the display actuator 50 thereby producing a device with no visible buttons.

According to one embodiment, one of the advantages of the display actuator 50 is that because the display provides user inputs, conventional user input means on electronic devices having displays can be substantially eliminated. Furthermore, the size of the display 52 can be maximized since the real estate is no longer needed for the conventional input means. For example, the display 52 can be configured to substantially fill the entire user interface portion of a hand-held electronic device without impairing the user input functionality. Alternatively, the hand-held electronic device can be minimized to the size of the display 52. In either case, the display 52 is allowed to utilize a greater amount of the real estate of the electronic device.

FIG. 8 is a simplified perspective diagram of an electronic device 100, in accordance with one embodiment of the present invention. The electronic device 100 includes a display actuator 102 that incorporates the functionality of a mechanical button(s) directly into a display device 104 seated within a housing 106. In other words, the display device 104 acts like a mechanical button(s). In this embodiment, the display device 104 is divided into a plurality of independent and spatially distinct button zones 108. The button zones 108 represent regions of the display device 104 that may be tilted relative to the housing 106 in order to implement distinct clicking actions. Although the display device 104 can be broken up into any number of button zones, in the illustrated embodiment, the display device 104 is separated into four button zones 108A-108D and thus implements four clicking actions.

The clicking actions are arranged to actuate one or more movement indicators contained inside the housing 106. That is, a particular button zone 108 moving from a first position (e.g., upright) to a second position (e.g., tilted) is caused to actuate a movement indicator. The movement indicators are configured to detect movements of display device 104 during the clicking action and to send signals corresponding to the movements to a controller of the electronic device. By way of example, the movement indicators may be switches, sensors and/or the like. In most cases, there is a movement indicator for each button zone. It should be noted, however, that this is not a limitation and that button zones do not necessarily require their own movement indicator. For example, a virtual button zone disposed between adjacent button zones can be created when two movement indicators associated with the adjacent button zones are activated at the same time. Using this technique, the four button zones shown in FIG. 8 may be expanded to include eight button zones without increasing the number of movement indicators.

The tilt of the display device 104 can be provided by a variety of different mechanisms including, for example, ball and socket arrangements, pivot pin arrangements, flexure arrangements, gimbal arrangements and the like. Each of these mechanisms allows the display device 104 to at least pivot about a first axis 110 so that the display device 104 can be tilted in the region of button zones 108A and 108D, and about a second axis 112 so that the display device 104 can be tilted in the region of button zones 108B and 108C.

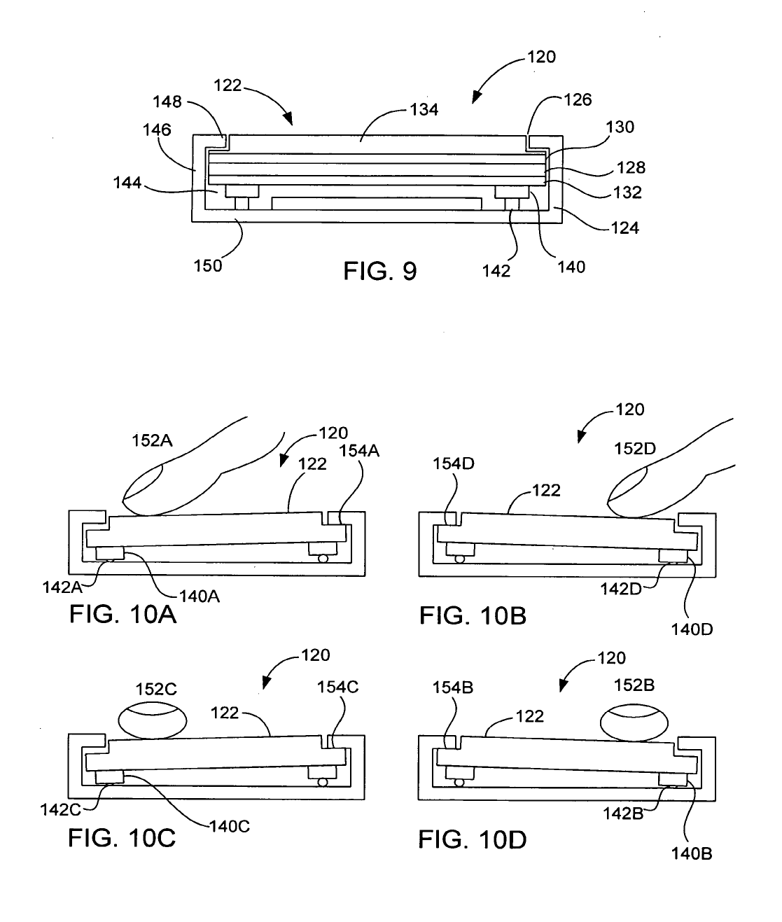

FIG. 9 is a side elevation view, in cross section, of an electronic device 120, in accordance with one embodiment of the present invention. The electronic device 120 may, for example, correspond to the electronic device shown in FIG. 8. The electronic device 120 includes a tiltable display device 122 seated within a housing 124. The housing 124 is configured to enclose the electrical components of the electronic device including the tiltable display device 122 and the control circuitry associated therewith. Although enclosed, the housing 124 typically includes an opening 126 for providing access to the display device 122. The tiltable display device 122, on the other hand, includes a display 128 and a touch screen 130 disposed above the display 128. In order to support and protect the display device 122 including the display 128 and touch screen 130 during movements, the display device 122 may additional include a platform 132 disposed underneath the display 128 and a transparent cover 134 disposed over the touch screen 130.

The transparent cover 134, which may be formed from a clear plastic material, may be part of the touch screen 130 or it may be a separate component. Furthermore, the platform 132, which is formed from a rigid material such as plastic or steel, may be a part of the display 128 or it may be a separate component. The platform 132 is primarily configured to help form a rigid structure to prevent bowing and flexing of the display device. The platform 132 may also include a printed circuit board to aid the connectivity of the devices coupled thereto. In some cases, all the elements of the display device 122 are attached together to form an integrated stacked unit. In other cases, the cover 134 and platform 132 are configured to encase the display 128 and touch screen 130. In fact, in cases such as this, the cover 134 may be configured to distribute a majority of the load exerted on the display device 122 to the platform 132 thereby protecting the display 128 and touch screen 130.

In order to generate input signals based on movements of the display device 122, the electronic device 120 further includes one or more mechanical switches 140 disposed between the display device 122 and the housing 124. The mechanical switches 140 include actuators 142 that generate input signals when depressed by movement of the display device 122. For example, tilting the display device 122 in the region of a mechanical switch 140 compresses the actuator 142 thereby generating input signals. In most cases, the actuators 142 are spring biased so that they extend away from the switch 140 and bias the display device 122 in the upright position. The mechanical switches 140 may be attached to the housing 124 or to the display device 122. In the illustrated embodiment, the mechanical switches 140 are attached to the backside of the display device 122, for example, at the platform 132. As such, the mechanical switches 140 and more particularly the actuators 142 act as legs for supporting the display device 122 in its upright position within the housing 124 (i.e., the actuators rest on the housing or some component mounted to the housing as for example a PCB). By way of example, the mechanical switches may correspond to tact switches and more particularly, enclosed SMT dome switches (dome switch packaged for SMT).

To elaborate further, the display device 122 is movably restrained within a cavity 144 provided in the housing 124. That is, the display device 122 is capable of moving within the cavity 144 while still being prevented from moving entirely out of the cavity 144 via the walls of the housing 124. In essence, the display device 122 floats in space relative to the housing 124 while still being constrained thereto (the display device is not attached to the housing). This is sometimes referred to as a gimbal.

As shown, the display device 122 is surrounded by side walls 146, a top wall 148 and bottom wall 150. The side walls 146 are configured to substantially prevent movements in the x and y directions as well as rotations about the z axis (e.g., excluding a small gap that allows a slight amount of play in order to prevent the display from binding with the housing during the tilting action). The top and bottom walls 148 and 150, however, are configured to allow movement (although limited) in the z direction as well as rotation about the x and y axis in order to provide the tilting action. That is, while the top and bottom walls 148 and 150 may constrain the display device 122 to the cavity 144, they also provide enough room for the display device 122 to tilt in order to depress the actuator 142 of the mechanical switches 140. Furthermore, the spring force provided by the mechanical switches 140 places the top surface of the display device 122 into mating engagement with the bottom surface of the top wall 148 of the housing 124 (e.g., upright position). When upright, the display device 122 may be flush with the outer peripheral surface of the housing 124 (as shown), or it may be recessed below the outer peripheral surface of the housing 124. It is generally believed that a flush mounted display is more aesthetically pleasing.

Referring to FIGS. 10A-10D, one embodiment of FIG. 9 will be described in greater detail. In this particular embodiment, the display device 122 is separated into a plurality of buttons zones 152A-152D similar to the embodiment of FIG. 8. Although not expressly stated in FIG. 9, each of the button zones in FIG. 10 includes a distinct mechanical switch 140 located underneath the display device 122.

As shown in FIGS. 10A-10D, a user simply presses on the top surface of the display device 122 in the location of the desired button zone 152A-152D in order to activate the mechanical switches 140A-140D disposed underneath the display device 122 in the location of the button zones 152A-152D. When activated, the switches 140 generate button signals that may be used by the electronic device 120. In each of these FIGS. 10A-10D, the force provided by the finger, works against the spring force of the actuator 142 until the switch 140 is activated. Although the display device 122 essentially floats within the cavity 144 of the housing 124, when the user presses on one side of the display device 122, the opposite side contacts the top wall 148 (opposite the press) thus causing the display device 122 to pivot about the contact point 154 without actuating the switch 140 in the region of the contact point 154. In essence, the display device 122 pivots about four different axes.

As shown in FIG. 10A, the display device 122 pivots about the contact point 154A when a user selects button zone 152A thereby causing the mechanical switch 140A to be activated. As shown in FIG. 10B, the display device 122 pivots about the contact point 154D when a user selects button zone 152D thereby causing the mechanical switch 140D to be activated. As shown in FIG. 10C, the display device 122 pivots about the contact point 154C when a user selects button zone 152C thereby causing the mechanical switch 140C to be activated. As shown in FIG. 10D, the display device 122 pivots about the contact point 154B when a user selects button zone 152B thereby causing the mechanical switch 140B to be activated. As should be appreciated, the signals generated by the various switches 140 may be used by the electronic device to perform various control functions such as initiate commands, make selections, or control motion in a display.

By way of example, and referring to FIGS. 8-10D, the first button zone 108A may be associated with a first command, the second button zone 108B may be associated with a second command, the third button zone 108C may be associated with a third command and the fourth button zone 108D may be associated with a fourth command. In the case of a music player, for example, the first button zone 108A may correspond to a menu command, the second button zone 108B may correspond to a seek backwards command, the third button zone 108C may correspond to a seek forward command, and the fourth button zone 108D may correspond to a play/pause command.

Alternatively or additionally, the buttons zones 108A-108D may be associated with arrow keys such that the actuation of the first button zone 108A initiates upward motion in the display 102, the actuation of the second button zone 108B initiates left side motion in the display 102, the actuation of the third button zone 108C initiates right side motion in the display 102, and the actuation of the fourth button zone 108D initiates downward motion in the display 102. This arrangement may be used to implement cursor control, selector control, scrolling, panning and the like.

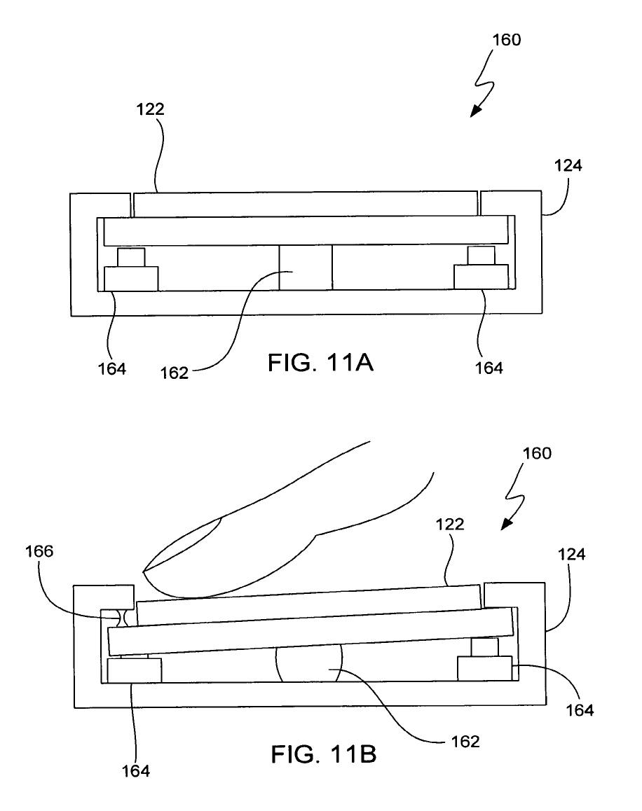

FIGS. 11A and 11B are diagrams of an electronic device 160, in accordance with an alternate embodiment of the present invention. This embodiment is similar to those shown in FIGS. 8-10D, however instead of relying on the spring action of a mechanical switch, the electronic device utilizes a separate spring component. As shown, the electronic device 160 includes a display device 122 containing all of its various layers. The display device 122 is coupled to the housing 124 via a spring element 162. The spring element 162, or in some cases flexure, allows the display device 122 to pivot in multiple directions when a force is applied to the display device 122 thereby allowing a plurality of button zones to be created. The spring element 162 also urges the display device 122 into an upright position similar to the previous embodiments.

When the display device 122 is depressed at a particular button zone (overcoming the spring force), the display device 122 moves into contact with one or more switches 164 positioned underneath the button zone of the display device 122. Upon contact, the switch 164 generates a button signal. The switch 164 may be attached to the display device 122 or the housing 124. In the illustrated embodiment, the switch 164 is attached to the housing 124. In some cases, a seal 166 may be provided to eliminate crack and gaps found between the display device 122 and the housing 124 when the display device is tilted. The spring element 162 may be widely varied. For example, it may be formed from one or more conventional springs, pistons, magnets or compliant members. In the illustrated embodiment, the spring element 162 takes the form of a compliant bumper formed from rubber or foam.

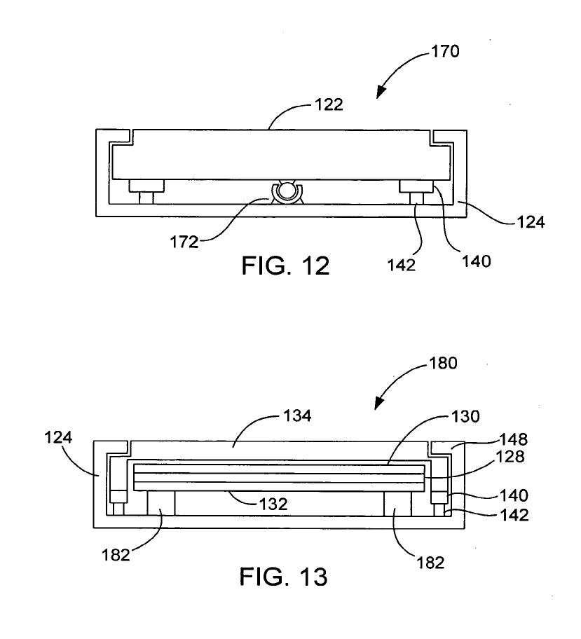

FIG. 12 is diagram of an electronic device 170, in accordance with an alternate embodiment of the present invention. This embodiment is similar to those shown in FIGS. 8-10D, however instead of relying on a gimbal feature, the electronic device 170 utilizes a ball and socket joint 172 to movably couple the display device 122 to the housing 124. Like the gimbal of FIGS. 9-10D, or the spring element of FIG. 11, the ball and socket joint 172 allows the display device 122 to pivot in multiple directions when a force is applied to the display device 122 thereby allowing a plurality of button zones to be created.

FIG. 13 is a diagram of an electronic device 180, in accordance with an alternate embodiment of the present invention. This embodiment is similar to those shown in FIGS. 8-10D, however unlike those embodiments, the display 128 and touch screen 130 are fixed. In this particular embodiment, the cover 134 provides the tilting action for engaging the mechanical switches 140. For example, the mechanical switches 140 may be attached to the bottom surface of the cover 134 at the peripheral edge of the cover 134 underneath the top wall 148. Furthermore, the display 128 and touch screen 130 may be supported in a fixed position underneath the tiltable cover 134 via one or more posts 182, which may include shock mounting features.

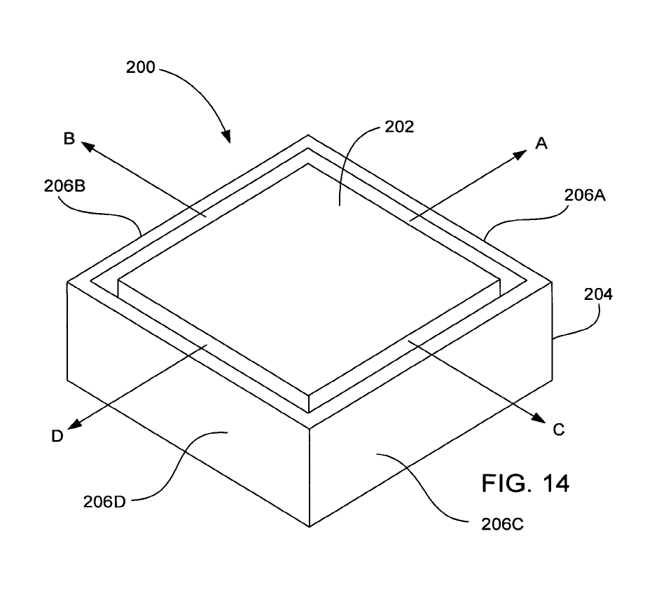

FIG. 14 is a perspective diagram of an electronic device 200, in accordance with one embodiment of the present invention. The electronic device 200 is similar to the embodiments described above in that different input signals are generated when moving the display to different positions. However, unlike those electronic devices, the electronic device 200 of FIG. 14 includes a sliding display device 202 rather than a tilting display device. As shown by the arrows, the display device 202 is configured to slide relative to the housing 204 in order to generate various input signals. Although the display device can be slid into an infinite number of positions including various diagonals between the arrows, in the illustrated embodiment, the display device 202 is configured to implement four clicking actions in directions towards the sides 206A-206D.

The clicking actions are arranged to actuate one or more movement indicators contained inside the housing 204. That is, display device 202 moving from a center position to a side position is caused to actuate a movement indicator. The movement indicators are configured to detect movements of display device 202 during the clicking action and to send signals corresponding to the movements to a controller of the electronic device 200. By way of example, the movement indicators may be switches, sensors and/or the like.

The sliding action of the display device 202 can be provided by a variety of different mechanisms including for example channel arrangements, roller arrangements, and the like. Each of these mechanisms allows the display device to at least slide in the direction of the arrows A-D, and in some cases may also allow the display device to slide in the x-y plane.

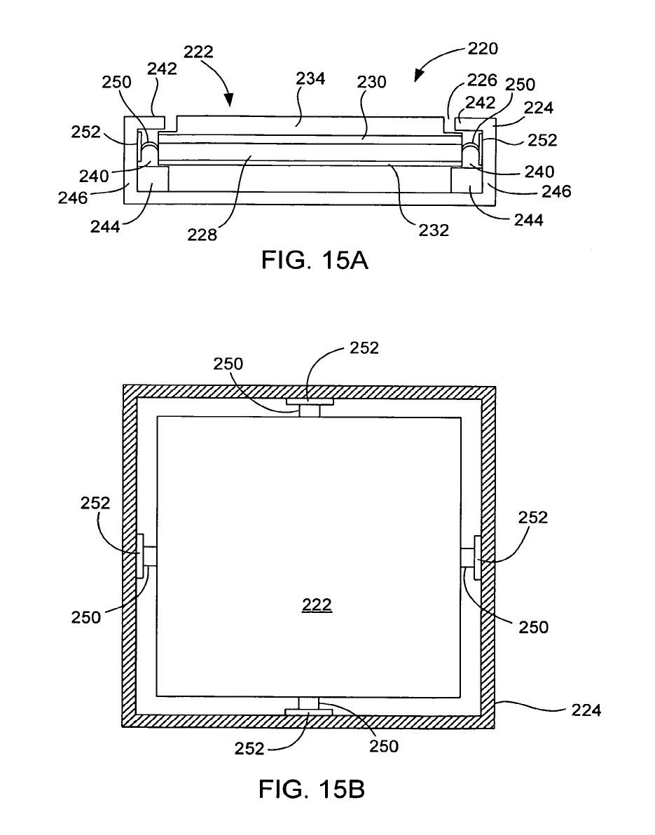

FIGS. 15A and 15B are diagrams of an electronic device 220, in accordance with one embodiment of the present invention. The electronic device 220 may for example correspond to the electronic device shown in FIG. 14. The electronic device 220 includes a display device 222 slidably seated within a housing 224. The housing 224 is configured to enclose the electrical components of the electronic device 200 including the slidable display device 222 and control circuitry associated therewith. Although enclosed, the housing 224 typically includes an opening 226 for providing access to the display device 222. The slidable display device 222, on the other hand, includes a display 228 and a touch screen 230 disposed above the display 228. In order to support and protect the display device 228 during movements, the display device 228 may additional include a platform 232 disposed underneath the display 228 and a transparent cover 234 disposed over the touch screen 230.

The transparent cover 234, which may be formed from a clear plastic material, may be part of the touch screen 230 or it may be a separate component. Furthermore, the platform 232, which is formed from a rigid material such as plastic or steel, may be a part of the display 228 or it may be a separate component. The platform 232 is primarily configured to help form a rigid structure to prevent bowing and flexing of the display device 222. In some cases, all the elements of the display device 222 are attached together to form an integrated stacked unit. In other cases, the cover 234 and platform 232 are configured to encase the display 228 and touch screen 230. In fact, in cases such as this, the cover 234 may be configured to distribute a majority of the load exerted on the display device 222 to the platform 232 thereby protecting the display 228 and touch screen 230.

In order to produce the sliding action, the display device 222 is disposed within a channel 240. The width of the channel 240 is generally sized and dimension to receive the ends of the display device 222 and the depth of the channel 240 is generally sized to constrain the display device 222 to the housing 224 while leaving room for sliding movement. As shown, the channel 240 is formed by a top wall 242 of the housing 224 and a lower support structure 244 that protrudes away from the side wall 246 of the housing 224. The lower support structure 244 may span the entire length of the housing 224 from side to side or it may only span a partial length (as shown). Furthermore, the lower support structure 244 may be an integral component of the housing 224 (as shown) or it may be a separate component attached thereto. Alternatively, only the platform may be disposed within the channel.

The top surface of the lower support structure 244 may include a frictionless or low friction surface to enhance the sliding action and preventing sticktion between the display device 222 and the lower support structure 244 when the display device 222 is slid therebetween. Alternatively or additionally, the bottom surface of the display device 222 may also include a frictionless or low friction surface. Alternatively or additionally, the top surface of the display device in the location of the channel and/or the bottom surface of the top wall 242 may include a frictionless or low friction surface. By way of example, the frictionless or low friction surface may be formed from frictionless or low friction material such as Teflon®. Alternatively, roller bearings may be used.

In most cases, the display device 222 is suspended within the channel 240 via one or more spring elements 250. The spring elements 250 are disposed between the sides of the display device 222 and the side walls of the housing 224. In the illustrated embodiment, there is a spring element 250 located at each of the sides of the display device 222. In most cases, the spring elements 250 are centered relative to the display device 222 so that the forces exerted by each spring elements 250 on the display device 222 are equally balanced. In essence, the spring elements 250 bias the display device 222 so that the display device 222 is centered relative to the opening 226 in the top wall 242. In order to slide the display device 222 from the center position to one of the side positions, the biasing force provided by the spring elements 250 must be overcome.

In order to generate input signals based on movements of the display device 222, the electronic device 220 further includes one or more sensors 252, such as force sensitive resistors (FSR), strain gauges or load cells, disposed between the display device 222 and the housing 224 in the location of the spring elements 250. These types of sensors 252 monitor the pressure exerted on them by the moving display device 222, and control circuitry generates signals when the force reaches a predetermined limit. By way of example, sliding the display device 222 towards the FSR sensor 252 compresses the FSR sensor 252 and as a result input signals are generated. The sensor 252 may be attached to the housing 224 or to the display device 222. In the illustrated embodiment, the sensors 252 are attached to the housing 224 between the spring element 250 and the housing 224.

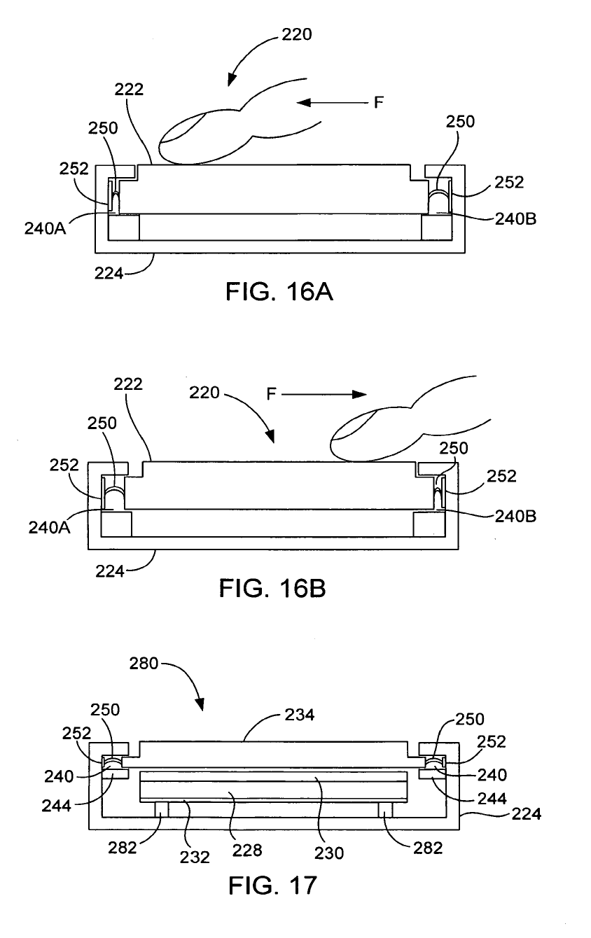

Referring to FIGS. 16A and 16B, one embodiment of FIG. 15 will be described in greater detail. In order to select a button feature, a user places their finger on the top surface of the display device 222 and slides the display device 222 in the direction of the desired button feature. During sliding, the force provided by the finger works against the spring force of the spring elements 250 disposed between the display device 222 and the housing 224. Furthermore, one end of the display device 222 is inserted deeper into the channel section 240A while the opposite end is removed, but not entirely from the channel section 240B, which is opposite the channel section 240A. As the display device 222 is inserted deeper into the channel 240A, a greater amount of force is applied to the sensor 252 through the spring element 250. Once a pre-set limit has been reached, the sensor circuit generates a button signal that may be used by the electronic device 220 to perform a control functions such as initiating commands, making selections, or controlling motion in a display.

FIG. 17 is a diagram of an electronic device 280, in accordance with an alternate embodiment of the present invention. This embodiment is similar to those shown in FIGS. 14-16, however unlike those embodiments, the display 228 and touch screen 230 are fixed. In this particular embodiment, the cover 234 provides the sliding action for engaging the sensors 252 rather than the entire display device. As shown, the cover 234 is retained within the channels 240 and suspended by the spring elements 250 while the display 228 and touch screen 230 are supported in a fixed position underneath the slidable cover 234 via one or more posts 282, which may include shock mounting features.

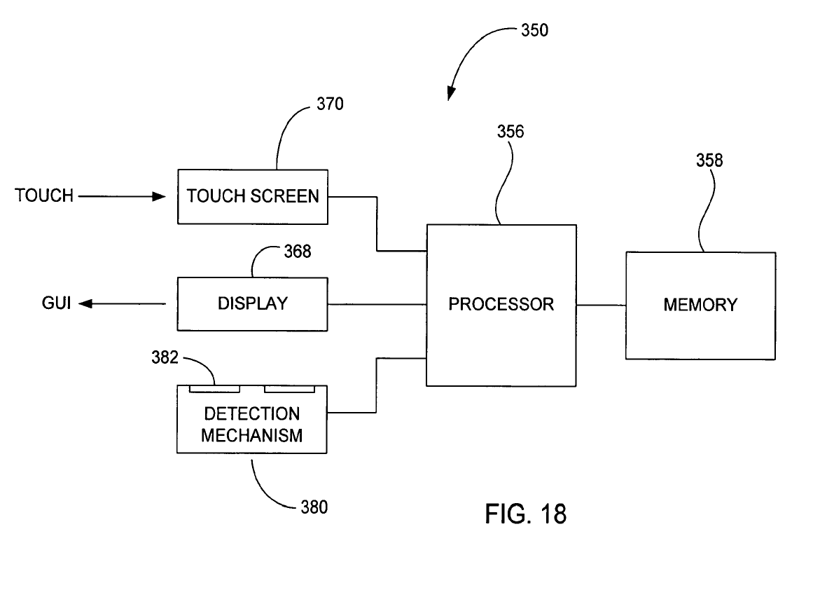

FIG. 18 is a block diagram of an exemplary electronic device 350, in accordance with one embodiment of the present invention. The electronic device typically includes a processor 356 configured to execute instructions and to carry out operations associated with the electronic device 350. For example, using instructions retrieved for example from memory, the processor 356 may control the reception and manipulation of input and output data between components of the electronic device 350. The processor 356 can be implemented on a single-chip, multiple chips or multiple electrical components. For example, various architectures can be used for the processor 356, including dedicated or embedded processor, single purpose processor, controller, ASIC, and so forth.

In most cases, the processor 356 together with an operating system operates to execute computer code and produce and use data. The operating system may correspond to well known operating systems such as OS/2, DOS, Unix, Linux, and Palm OS, or alternatively to special purpose operating system, such as those used for limited purpose appliance-type devices (e.g., media players). The operating system, other computer code and data may reside within a memory block 358 that is operatively coupled to the processor 356. Memory block 358 generally provides a place to store computer code and data that are used by the electronic device 350. By way of example, the memory block 358 may include Read-Only Memory (ROM), Random-Access Memory (RAM), hard disk drive and/or the like.

The electronic device 350 also includes a movable display 368 that is operatively coupled to the processor 356. The display 368 is generally configured to display a graphical user interface (GUI) that provides an easy to use interface between a user of the electronic device 350 and the operating system or application running thereon. The display 368 may for example be a liquid crystal display (LCD).

The electronic device 350 also includes a touch screen 370 that is operatively coupled to the processor 356. The touch screen 370 is configured to transfer data from the outside world into the electronic device 350. The touch screen 370 may for example be used to perform tracking and to make selections with respect to the GUI on the display 368. The touch screen 370 may also be used to issue commands in the electronic device 350.

The touch screen 370, which is positioned in front of the display 368, recognizes touches, as well as the position and magnitude of touches on a touch sensitive surface. The touch screen 370 reports the touches to the processor 356 and the processor 356 interprets the touches in accordance with its programming. For example, the processor 356 may initiate a task in accordance with a particular touch. A dedicated processor can be used to process touches locally and reduce demand for the main processor of the electronic device.

The touch screen 370 may be based on sensing technologies including but not limited to capacitive sensing, resistive sensing, surface acoustic wave sensing, and/or the like. Furthermore, the touch screen may be based on single point sensing or multipoint sensing. Single point sensing is capable of only distinguishing a single touch, while multipoint sensing is capable of distinguishing multiple touches that occur at the same time. By way of example, a touch screen which can be used herein is shown and described in greater detail in copending and commonly assigned U.S. patent application Ser. No. 10/840,862, titled “MULTIPOINT TOUCHSCREEN,” filed on May 6, 2004, and which is hereby incorporated herein by reference.

In some cases, the electronic device 350 may be designed to recognize gestures applied to the touch screen 370 and to control aspects of the electronic device 350 based on the gestures. Generally speaking, a gesture is defined as a stylized interaction with an input device that is mapped to one or more specific computing operations. The gestures may be made through various hand, and more particularly finger motions. Alternatively or additionally, the gestures may be made with a stylus. In all of these cases, the touch screen 370 receives the gestures and the processor 356 executes instructions to carry out operations associated with the gestures. In addition, the memory block 358 may include a gesture operational program, which may be part of the operating system or a separate application. The gestural operation program generally includes a set of instructions that recognizes the occurrence of gestures and informs one or more software agents of the gestures and/or what action(s) to take in response to the gestures. By way of example, gesture methods, which can be used herein, are shown and described in greater detail in copending and commonly assigned U.S. patent application Ser. No. 10/903,964, titled “GESTURES FOR TOUCH SENSITIVE INPUT DEVICES,” filed on Jul. 30, 2004 and which is hereby incorporated herein by reference.

The electronic device 350 also includes a detection mechanism 380 that is operatively coupled to the processor 356. The detection mechanism 380, utilizing movement indicators 382 such as switches and sensors, is configured to monitor movements of the display 368 or some component thereof (e.g., cover), and to send signals indicative of the movements to the processor 356, which interprets the signals in accordance with its programming. In some cases, a dedicated processor can be used to process the movement signals and reduce demand for the main processor of the electronic device.

As mentioned above, the movable display 368 is configured to mimic a mechanical actuator such as a clickable button, a sliding switch or a joystick. The display region of the electronic device 350 can therefore be used to transfer data from the outside world into the electronic device 350. The display region may for example be used to issue commands in the electronic device 350 or control motion and make selections with respect to the GUI on the display 368.

In one particular embodiment of the present invention, the electronic devices described above correspond to hand-held electronic devices with small form factors. As used herein, the term “hand held” means that the electronic device is typically operated while being held in a hand and thus the device is sized and dimension for such use. Examples of hand held devices include PDAs, Cellular Phones, Media players (e.g., music players, video players, game players), Cameras, GPS receivers, Remote Controls, and the like.

Hand held electronic devices may be directed at one-handed operation or two-handed operation. In one-handed operation, a single hand is used to both support the device as well as to perform operations with the user interface during use. Cellular phones such as handsets, and media players such as music players are examples of hand held devices that can be operated solely with one hand. In either case, a user may grasp the device in one hand between the fingers and the palm and use the thumb to make entries using keys, buttons or a navigation pad. In two-handed operation, one hand is used to support the device while the other hand performs operations with a user interface during use or alternatively both hands support the device as well as perform operations during use. PDA's and game players are examples of hand held device that are typically operated with two hands. In the case of the PDA, for example, the user may grasp the device with one hand and make entries using the other hand, as for example using a stylus. In the case of the game player, the user typically grasps the device in both hands and makes entries using either or both hands while holding the device.

The display actuator of the present invention is a perfect fit for small form factor devices such as hand held devices, which have limited space available for input interfaces, and which require central placement of input interfaces to permit operation while being carried around. This is especially true when you consider that the functionality of handheld devices have begun to merge into a single hand held device (e.g., smart phones). At some point, there is not enough real estate on the device for housing all the necessary buttons and switches without decreasing the size of the display or increasing the size of the device, both of which leave a negative impression on the user. In fact, increasing the size of the device may lead to devices, which are no longer considered “hand-held.”

When the display is incorporated into the hand held device (e.g., integrated into the device housing), the display presents the visual information associated with the hand-held electronic device, while the mechanical action of the display and possibly the touch sensitivity of the touch screen provides the input means necessary to interact with the hand-held electronic device. The display actuator can therefore reduce the number of input devices needed to support the device and in many cases completely eliminate input devices other than the display actuator. As a result, the hand-held electronic device may appear to only have a display and no input means (or very few). The device is therefore more aesthetically pleasing (e.g., smooth surface with no breaks gaps or lines), and in many cases can be made smaller without sacrificing screen size and input functionality, which is very beneficial for hand-held electronic device especially those hand-held electronic device that are operated using one hand (some hand-held electronic device require two handed operation while others do not). Alternatively, the screen size can be made larger without affecting the size of the device and input functionality, i.e., the display can be made to substantially fill the entire front surface of the hand held device.

In one particular implementation, the hand held device is a music player and the display actuator is configured to substantially fill the entire front surface of the music player. The display actuator is the primary input means of the music player and in some cases is the only input means. Furthermore, the display actuator is configured to generate control signals associated with a music player. For example, the display actuator may include button functions including, Select, Play/Pause, Next, Previous and Menu. Alternatively or additionally, the button functions may include volume up and volume down.

While this aspect of the invention has been described in terms of several preferred embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

According to a second aspect, the invention relates, in one embodiment, to an input device. The input device, in one embodiment, includes a touch pad capable of detecting an object in close proximity thereto. More particularly, the invention relates to a touch pad capable of moving in order to increase the functionality of the touch pad. For example, the touch pad may be depressible so as to provide additional button functionality. In one embodiment, the input device includes a movable touch pad configured to generate a first control signal when the movable touchpad is moved and a second control signal when an object is positioned over the movable touchpad.

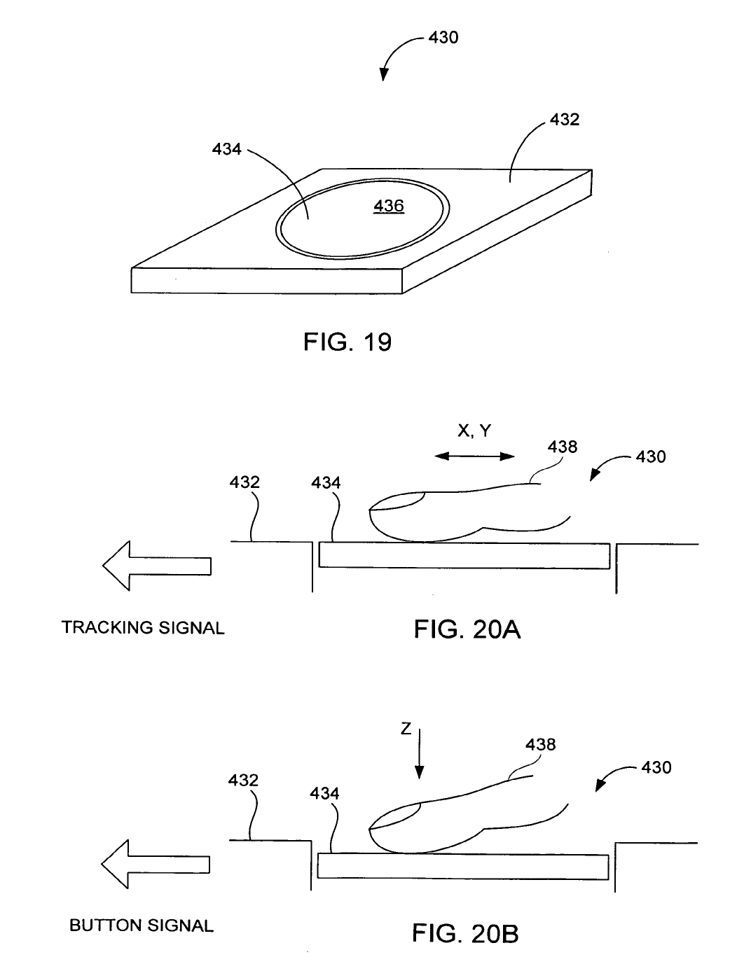

Embodiments of the second aspect of the invention are discussed below with reference to FIGS. 19-37B. However, those skilled in the art will readily appreciate that the detailed description given herein with respect to these figures is for explanatory purposes as the invention extends beyond these limited embodiments.

FIG. 19 is a simplified perspective view of an input device 430, in accordance with one embodiment of the present invention. The input device 430 is generally configured to send information or data to an electronic device in order to perform an action on a display screen (e.g., via a graphical user interface). For example, moving an input pointer, making a selection, providing instructions, etc. The input device may interact with the electronic device through a wired (e.g., cable/connector) or wireless connection (e.g., IR, bluetooth, etc.). The input device 430 may be a stand alone unit or it may be integrated into the electronic device. When a stand alone unit, the input device typically has its own enclosure. When integrated with an electronic device, the input device typically uses the enclosure of the electronic device. In either case, the input device may be structurally coupled to the enclosure as for example through screws, snaps, retainers, adhesives and the like. In some cases, the input device may be removably coupled to the electronic device as for example through a docking station. The electronic device to which the input device is coupled may correspond to any consumer related electronic product. By way of example, the electronic device may correspond to a computer such as desktop computer, laptop computer or PDA, a media player such as a music player, a communication device such as a cellular phone, another input device such as a keyboard, and the like.

As shown in FIG. 19, the input device 430 includes a frame 432 (or support structure) and a touch pad 434. The frame 432 provides a structure for supporting the components of the input device. The frame 432 in the form of a housing may also enclose or contain the components of the input device. The components, which include the touch pad 434, may correspond to electrical, optical and/or mechanical components for operating the input device 430.

The touch pad 434 provides an intuitive interface configured to provide one or more control functions for controlling various applications associated with the electronic device to which it is attached. By way of example, the touch initiated control function may be used to move an object or perform an action on the display screen or to make selections or issue commands associated with operating the electronic device. In order to implement the touch initiated control function, the touch pad 434 may be arranged to receive input from a finger (or object) moving across the surface of the touch pad 434 (e.g., linearly, radially, rotary, etc.), from a finger holding a particular position on the touch pad 434 and/or by a finger tapping on a particular position of the touch pad 434. As should be appreciated, the touch pad 434 provides easy one-handed operation, i.e., lets a user interact with the electronic device with one or more fingers.

The touch pad 434 may be widely varied. For example, the touch pad 434 may be a conventional touch pad based on the Cartesian coordinate system, or the touch pad 434 may be a touch pad based on a Polar coordinate system. An example of a touch pad based on polar coordinates may be found in U.S. patent application Ser. No. 10/188,182, entitled “TOUCH PAD FOR HANDHELD DEVICE,” filed Jul. 1, 2002, which is herein incorporated by reference. Furthermore, the touch pad 434 may be used in a relative and/or absolute mode. In absolute mode, the touch pad 434 reports the absolute coordinates of where it is being touched. For example x, y in the case of the Cartesian coordinate system or (r, θ) in the case of the Polar coordinate system. In relative mode, the touch pad 434 reports the direction and/or distance of change, for example, left/right, up/down, and the like. In most cases, the signals produced by the touch pad 434 direct motion on the display screen in a direction similar to the direction of the finger as it is moved across the surface of the touch pad 434.

The shape of the touch pad 434 may be widely varied. For example, the touch pad 434 may be circular, oval, square, rectangular, triangular, and the like. In general, the outer perimeter of the touch pad 434 defines the working boundary of the touch pad 434. In the illustrated embodiment, the touch pad is circular. Circular touch pads allow a user to continuously swirl a finger in a free manner, i.e., the finger can be rotated through 360 degrees of rotation without stopping. Furthermore, the user can rotate his or her finger tangentially from all sides thus giving it more range of finger positions. Both of these features may help when performing a scrolling function. Furthermore, the size of the touch pad 434 generally corresponds to a size that allows them to be easily manipulated by a user (e.g., the size of a finger tip or larger).

The touch pad 434, which generally takes the form of a rigid planar platform, includes a touchable outer surface 436 for receiving a finger (or object) for manipulation of the touch pad. Although not shown in FIG. 19, beneath the touchable outer surface 436 is a sensor arrangement that is sensitive to such things as the pressure and motion of a finger thereon. The sensor arrangement typically includes a plurality of sensors that are configured to activate as the finger sits on, taps on or passes over them. In the simplest case, an electrical signal is produced each time the finger is positioned over a sensor. The number of signals in a given time frame may indicate location, direction, speed and acceleration of the finger on the touch pad 434, i.e., the more signals, the more the user moved his or her finger. In most cases, the signals are monitored by an electronic interface that converts the number, combination and frequency of the signals into location, direction, speed and acceleration information. This information may then be used by the electronic device to perform the desired control function on the display screen. The sensor arrangement may be widely varied. By way of example, the sensors may be based on resistive sensing, surface acoustic wave sensing, pressure sensing (e.g., strain gauge), optical sensing, capacitive sensing and the like.

In the illustrated embodiment, the touch pad 434 is based on capacitive sensing. As is generally well known, a capacitively based touch pad is arranged to detect changes in capacitance as the user moves an object such as a finger around the touch pad. In most cases, the capacitive touch pad includes a protective shield, one or more electrode layers, a circuit board and associated electronics including an application specific integrated circuit (ASIC). The protective shield is placed over the electrodes; the electrodes are mounted on the top surface of the circuit board; and the ASIC is mounted on the bottom surface of the circuit board. The protective shield serves to protect the underlayers and to provide a surface for allowing a finger to slide thereon. The surface is generally smooth so that the finger does not stick to it when moved. The protective shield also provides an insulating layer between the finger and the electrode layers. The electrode layer includes a plurality of spatially distinct electrodes. Any suitable number of electrodes may be used. In most cases, it would be desirable to increase the number of electrodes so as to provide higher resolution, i.e., more information can be used for things such as acceleration.

Capacitive sensing works according to the principals of capacitance. As should be appreciated, whenever two electrically conductive members come close to one another without actually touching, their electric fields interact to form capacitance. In the configuration discussed above, the first electrically conductive member is one or more of the electrodes and the second electrically conductive member is the finger of the user. Accordingly, as the finger approaches the touch pad, a tiny capacitance forms between the finger and the electrodes in close proximity to the finger. The capacitance in each of the electrodes is measured by ASIC located on the backside of the circuit board. By detecting changes in capacitance at each of the electrodes, the ASIC can determine the location, direction, speed and acceleration of the finger as it is moved across the touch pad. The ASIC can also report this information in a form that can be used by the electronic device.

In accordance with one embodiment, the touch pad 434 is movable relative to the frame 432 so as to initiate another set of signals (other than just tracking signals). By way of example, the touch pad 434 in the form of the rigid planar platform may rotate, pivot, slide, translate, flex and/or the like relative to the frame 432. The touch pad 434 may be coupled to the frame 432 and/or it may be movably restrained by the frame 432. By way of example, the touch pad 434 may be coupled to the frame 432 through axels, pin joints, slider joints, ball and socket joints, flexure joints, magnets, cushions and/or the like. The touch pad 434 may also float within a space of the frame (e.g., gimbal). It should be noted that the input device 430 may additionally include a combination of joints such as a pivot/translating joint, pivot/flexure joint, pivot/ball and socket joint, translating/flexure joint, and the like to increase the range of motion (e.g., increase the degree of freedom). When moved, the touch pad 434 is configured to actuate a circuit that generates one or more signals. The circuit generally includes one or more movement indicators such as switches, sensors, encoders, and the like. An example of a rotating platform which can be modified to include a touch pad may be found in U.S. patent application Ser. No. 10/072,765, entitled “MOUSE HAVING A ROTARY DIAL,” filed Feb. 7, 2002, which is herein incorporated by reference.

In the illustrated embodiment, the touch pad 434 takes the form of a depressible button that performs one or more mechanical clicking actions. That is, a portion or the entire touch pad 434 acts like a single or multiple button such that one or more additional button functions may be implemented by pressing on the touch pad 434 rather tapping on the touch pad or using a separate button. As shown in FIGS. 20A and 20B, according to one embodiment of the invention, the touch pad 434 is capable of moving between an upright position (FIG. 20A) and a depressed position (FIG. 20B) when a substantial force from a finger 438, palm, hand or other object is applied to the touch pad 434. The touch pad 434 is typically spring biased in the upright position as for example through a spring member. The touch pad 434 moves to the depressed position when the spring bias is overcome by an object pressing on the touch pad 434.

As shown in FIG. 20A, in the upright position, the touch pad 434 generates tracking signals when an object such as a user's finger is moved over the top surface of the touch pad in the x, y plane. As shown in FIG. 20B, in the depressed position (z direction), the touch pad 434 generates one or more button signals. The button signals may be used for various functionalities including but not limited to making selections or issuing commands associated with operating an electronic device. By way of example, in the case of a music player, the button functions may be associated with opening a menu, playing a song, fast forwarding a song, seeking through a menu and the like. In some cases, the input device 430 may be arranged to provide both the tracking signals and the button signal at the same time, i.e., simultaneously depressing the touch pad 434 in the z direction while moving planarly in the x, y directions. In other cases, the input device 430 may be arranged to only provide a button signal when the touch pad 434 is depressed and a tracking signal when the touch pad 434 is upright. The latter case generally corresponds to the embodiment shown in FIGS. 20A and 20B.

To elaborate, the touch pad 434 is configured to actuate one or more movement indicators, which are capable of generating the button signal, when the touch pad 434 is moved to the depressed position. The movement indicators are typically located within the frame 432 and may be coupled to the touch pad 434 and/or the frame 432. The movement indicators may be any combination of switches and sensors. Switches are generally configured to provide pulsed or binary data such as activate (on) or deactivate (off). By way of example, an underside portion of the touch pad 434 may be configured to contact or engage (and thus activate) a switch when the user presses on the touch pad 434. The sensors, on the other hand, are generally configured to provide continuous or analog data. By way of example, the sensor may be configured to measure the position or the amount of tilt of the touch pad 434 relative to the frame when a user presses on the touch pad 434. Any suitable mechanical, electrical and/or optical switch or sensor may be used. For example, tact switches, force sensitive resistors, pressure sensors, proximity sensors, and the like may be used. In some case, the spring bias for placing the touch pad 434 in the upright position is provided by a movement indicator that includes a spring action.

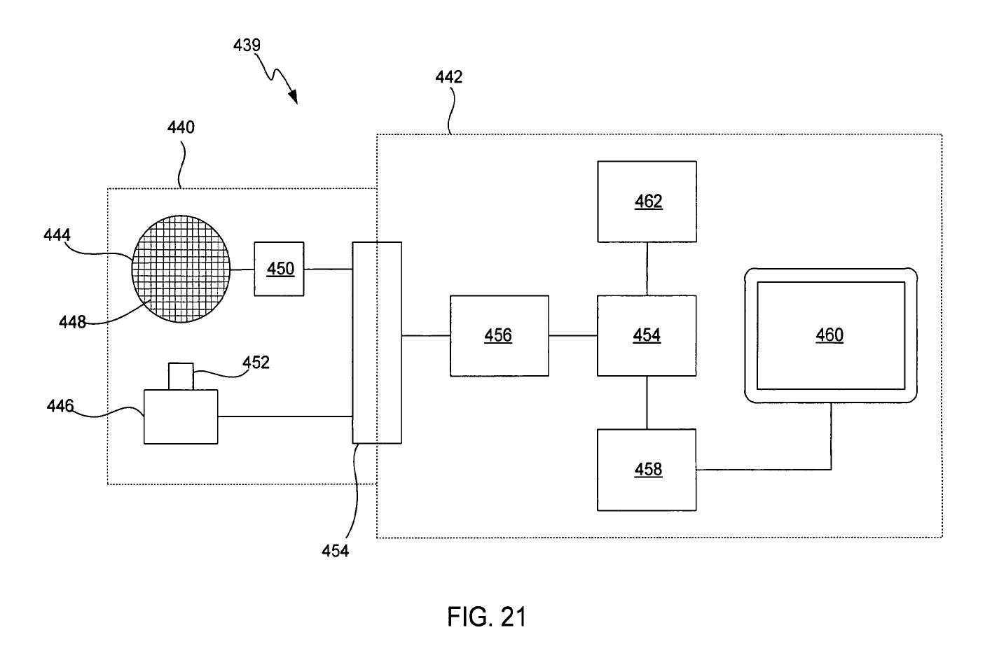

FIG. 21 is a simplified block diagram of a computing system, in accordance with one embodiment of the present invention. The computing system generally includes an input device 440 operatively connected to a computing device 442. By way of example, the input device 440 may generally correspond to the input device 430 shown in FIGS. 19, 20A and 20B, and the computing device 442 may correspond to a computer, PDA, media player or the like. As shown, the input device 440 includes a depressible touch pad 444 and one or more movement indicators 446. The touch pad 444 is configured to generate tracking signals and the movement indicator 446 is configured to generate a button signal when the touch pad is depressed. Although the touch pad 444 may be widely varied, in this embodiment, the touch pad 444 includes capacitance sensors 448 and a control system 450 for acquiring the position signals from the sensors 448 and supplying the signals to the computing device 442. The control system 450 may include an application specific integrated circuit (ASIC) that is configured to monitor the signals from the sensors 448, to compute the angular location, direction, speed and acceleration of the monitored signals and to report this information to a processor of the computing device 442. The movement indicator 446 may also be widely varied. In this embodiment, however, the movement indicator 446 takes the form of a switch that generates a button signal when the touch pad 444 is depressed. The switch 446 may correspond to a mechanical, electrical or optical style switch. In one particular implementation, the switch 446 is a mechanical style switch that includes a protruding actuator 452 that may be pushed by the touch pad 444 to generate the button signal. By way of example, the switch may be a tact switch.

Both the touch pad 444 and the switch 446 are operatively coupled to the computing device 442 through a communication interface 454. The communication interface provides a connection point for direct or indirect connection between the input device and the electronic device. The communication interface 454 may be wired (wires, cables, connectors) or wireless (e.g., transmitter/receiver).

Referring to the computing device 442, the computing device 442 generally includes a processor 454 (e.g., CPU or microprocessor) configured to execute instructions and to carry out operations associated with the computing device 442. For example, using instructions retrieved for example from memory, the processor may control the reception and manipulation of input and output data between components of the computing device 442. In most cases, the processor 454 executes instruction under the control of an operating system or other software. The processor 454 can be a single-chip processor or can be implemented with multiple components.

The computing device 442 also includes an input/output (I/O) controller 456 that is operatively coupled to the processor 454. The (I/O) controller 456 may be integrated with the processor 454 or it may be a separate component as shown. The I/O controller 456 is generally configured to control interactions with one or more I/O devices that can be coupled to the computing device 442 as for example the input device 440. The I/O controller 456 generally operates by exchanging data between the computing device 442 and I/O devices that desire to communicate with the computing device 442.

The computing device 442 also includes a display controller 458 that is operatively coupled to the processor 454. The display controller 458 may be integrated with the processor 454 or it may be a separate component as shown. The display controller 458 is configured to process display commands to produce text and graphics on a display screen 460. By way of example, the display screen 460 may be a monochrome display, color graphics adapter (CGA) display, enhanced graphics adapter (EGA) display, variable-graphics-array (VGA) display, super VGA display, liquid crystal display (e.g., active matrix, passive matrix and the like), cathode ray tube (CRT), plasma displays and the like. In the illustrated embodiment, the display device corresponds to a liquid crystal display (LCD).

In most cases, the processor 454 together with an operating system operates to execute computer code and produce and use data. The computer code and data may reside within a program storage area 462 that is operatively coupled to the processor 454. Program storage area 462 generally provides a place to hold data that is being used by the computing device 442. By way of example, the program storage area may include Read-Only Memory (ROM), Random-Access Memory (RAM), hard disk drive and/or the like. The computer code and data could also reside on a removable program medium and loaded or installed onto the computing device when needed. In one embodiment, program storage area 462 is configured to store information for controlling how the tracking and button signals generated by the input device are used by the computing device 442.

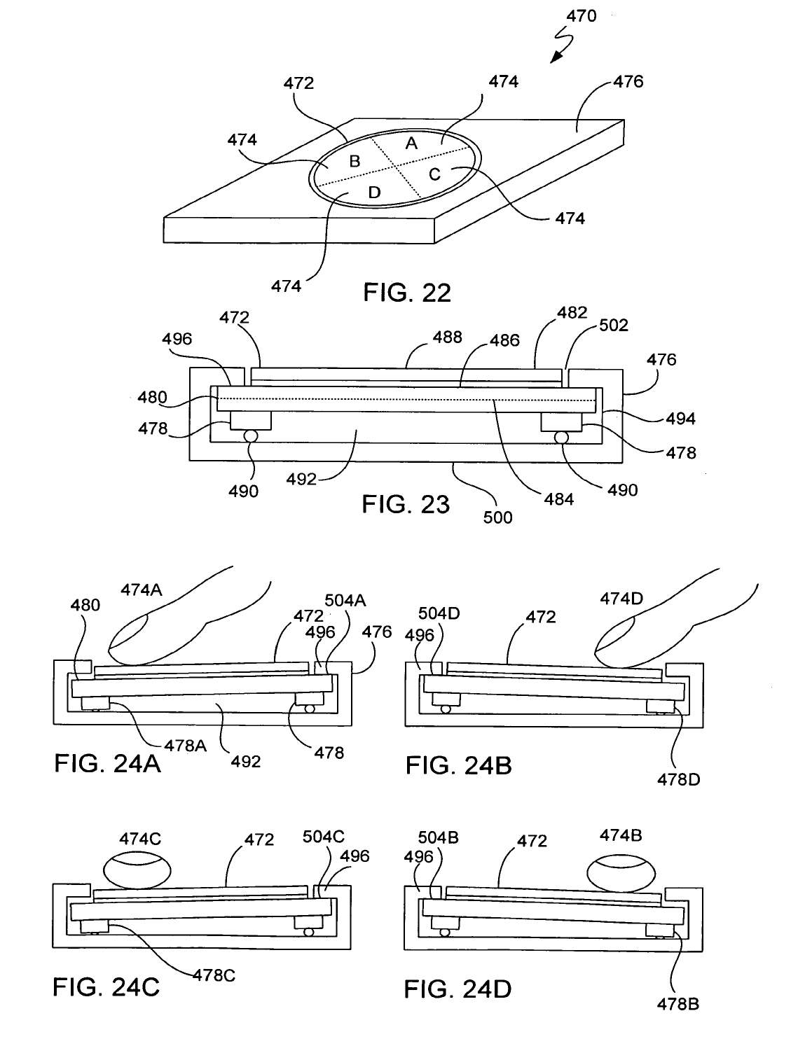

FIG. 22 is a simplified perspective diagram of an input device 470, in accordance with one embodiment of the present invention. Like the input device shown in the embodiment of FIGS. 20A and 20B, this input device 470 incorporates the functionality of a button (or buttons) directly into a touch pad 472, i.e., the touch pad acts like a button. In this embodiment, however, the touch pad 472 is divided into a plurality of independent and spatially distinct button zones 474. The button zones 474 represent regions of the touch pad 472 that may be moved by a user to implement distinct button functions. The dotted lines represent areas of the touch pad 472 that make up an individual button zone. Any number of button zones may be used, for example, two or more, four, eight, etc. In the illustrated embodiment, the touch pad 472 includes four button zones 474 (i.e., zones A-D).

As should be appreciated, the button functions generated by pressing on each button zone may include selecting an item on the screen, opening a file or document, executing instructions, starting a program, viewing a menu, and/or the like. The button functions may also include functions that make it easier to navigate through the electronic system, as for example, zoom, scroll, open different menus, home the input pointer, perform keyboard related actions such as enter, delete, insert, page up/down, and the like. In the case of a music player, one of the button zones may be used to access a menu on the display screen, a second button zone may be used to seek forward through a list of songs or fast forward through a currently played song, a third button zone may be used to seek backwards through a list of songs or fast rearward through a currently played song, and a fourth button zone may be used to pause or stop a song that is being played.

To elaborate, the touch pad 472 is capable of moving relative to a frame 476 so as to create a clicking action for each of the button zones 474 (i.e., zones A-D). The frame 476 may be formed from a single component or it may be a combination of assembled components. The clicking actions are generally arranged to actuate one or more movement indicators contained inside the frame 476. That is, a particular button zone moving from a first position (e.g., upright) to a second position (e.g., depressed) is caused to actuate a movement indicator. The movement indicators are configured to sense movements of the button zones during the clicking action and to send signals corresponding to the movements to the electronic device. By way of example, the movement indicators may be switches, sensors and/or the like.

The arrangement of movement indicators may be widely varied. In one embodiment, the input device may include a movement indicator for each button zone 474. That is, there may be a movement indicator corresponding to every button zone 474. For example, if there are two button zones, then there will be two movement indicators. In another embodiment, the movement indicators may be arranged in a manner that simulates the existence of a movement indicator for each button zone 474. For example, two movement indicators may be used to form three button zones. In another embodiment, the movement indicators may be configured to form larger or smaller button zones. By way of example, this may be accomplished by careful positioning of the movement indicators or by using more than one movement indicator for each button zone. It should be noted that the above embodiments are not a limitation and that the arrangement of movement indicators may vary according to the specific needs of each device.

The movements of each of the button zones 474 may be provided by various rotations, pivots, translations, flexes and the like. In one embodiment, the touch pad 472 is configured to gimbal relative to the frame 476 so as to generate clicking actions for each of the button zones. By gimbal, it is generally meant that the touch pad 472 is able to float in space relative to the frame 476 while still being constrained thereto. The gimbal may allow the touch pad 472 to move in single or multiple degrees of freedom (DOF) relative to the housing. For example, movements in the x, y and/or z directions and/or rotations about the x, y, and/or z axes (θₓ θ_{y} θ_{z}).

Referring to FIG. 23, a particular implementation of the multiple button zone touch pad 472 of FIG. 22 will be described. In this embodiment, the input device 470 includes a movement indicator 478 for each of the button zones 474 shown in FIG. 22. That is, there is a movement indicator 478 disposed beneath each of the button zones 474. Furthermore, the touch pad 472 is configured to gimbal relative to the frame 476 in order to provide clicking actions for each of the button zones 474. The gimbal is generally achieved by movably constraining the touch pad 472 within the frame 476.

As shown in FIG. 23, the touch pad 472 includes various layers including a rigid platform 480 and a touch sensitive surface 482 for tracking finger movements. In one embodiment, the touch pad 472 is based on capacitive sensing and thus the rigid platform 480 includes a circuit board 484, and the touch sensitive surface 482 includes an electrode layer 486 and a protective layer 488. The electrode layer 486 is disposed on the top surface of the circuit board 484, and the protective layer 488 is disposed over the electrode layer 486. Although not shown in FIG. 23, the rigid platform 480 may also include a stiffening plate to stiffen the circuit board 484.

The movement indicators 478 may be widely varied, however, in this embodiment they take the form of mechanical switches. The mechanical switches 478 are typically disposed between the platform 480 and the frame 476. The mechanical switches 478 may be attached to the frame 476 or to the platform 480. In the illustrated embodiment, the mechanical switches 478 are attached to the backside of the circuit board 484 of the platform 480 thus forming an integrated unit. They are generally attached in a location that places them beneath the appropriate button zone 474. As shown, the mechanical switches 478 include actuators 490 that are spring biased so that they extend away from the circuit board 484. As such, the mechanical switches 478 act as legs for supporting the touch pad 472 in its upright position within the frame 476 (i.e., the actuators 490 rest on the frame 476). By way of example, the mechanical switches may correspond to tact switches and more particularly, enclosed SMT dome switches (dome switch packaged for SMT).

Moving along, the integrated unit of the touch pad 472 and switches 478 is restrained within a space 492 provided in the frame 476. The integrated unit 472/478 is capable of moving within the space 492 while still being prevented from moving entirely out of the space 492 via the walls of the frame 476. The shape of the space 492 generally coincides with the shape of the integrated unit 472/478. As such, the unit is substantially restrained along the x and y axes via a side wall 494 of the frame 476 and along the z axis and rotationally about the x and y axis via a top wall 496 and a bottom wall 500 of the frame 476. A small gap may be provided between the side walls and the platform to allow the touch pad to move to its four positions without obstruction (e.g., a slight amount of play). In some cases, the platform 480 may include tabs that extend along the x and y axis so as to prevent rotation about the z axis. Furthermore, the top wall 496 includes an opening 502 for providing access to the touch sensitive surface 482 of the touch pad 472. The spring force provided by the mechanical switches 478 places the touch pad 472 into mating engagement with the top wall 496 of the frame 476 (e.g., upright position) and the gimbal substantially eliminates gaps and cracks found therebetween.

Referring to FIGS. 24A-24D, according to one embodiment, a user simply presses on the top surface of the touch pad 472 in the location of the desired button zone 474A in order to activate the switch 478 disposed underneath the desired button zone A-D. When activated, the switches 478 generate button signals that may be used by an electronic device. In this embodiment, the force provided by the finger works against the spring force of the switch 478 until the switch 478 is activated. Although the platform 480 essentially floats within the space of the frame 476, when the user presses on one side of the touch pad 472, the opposite side contacts the top wall 496 thus causing the touch pad 472 to pivot about the contact point without actuating the opposite switch 478. In essence, the touch pad 472 pivots about four different axes, although two of the axes are substantially parallel to one another. As shown in FIG. 24A, the touch pad 472 pivots about the contact point 504A when a user selects button zone 474A thereby causing the mechanical switch 478A to be activated. As shown in FIG. 24B, the touch pad 472 pivots about the contact point 504D when a user selects button zone 474D thereby causing the mechanical switch 478D to be activated. As shown in FIG. 24C, the touch pad 472 pivots about the contact point 504C when a user selects button zone 474C thereby causing the mechanical switch 478C to be activated. As shown in FIG. 24D, the touch pad 472 pivots about the contact point 504B when a user selects button zone 474B thereby causing the mechanical switch 478B to be activated.

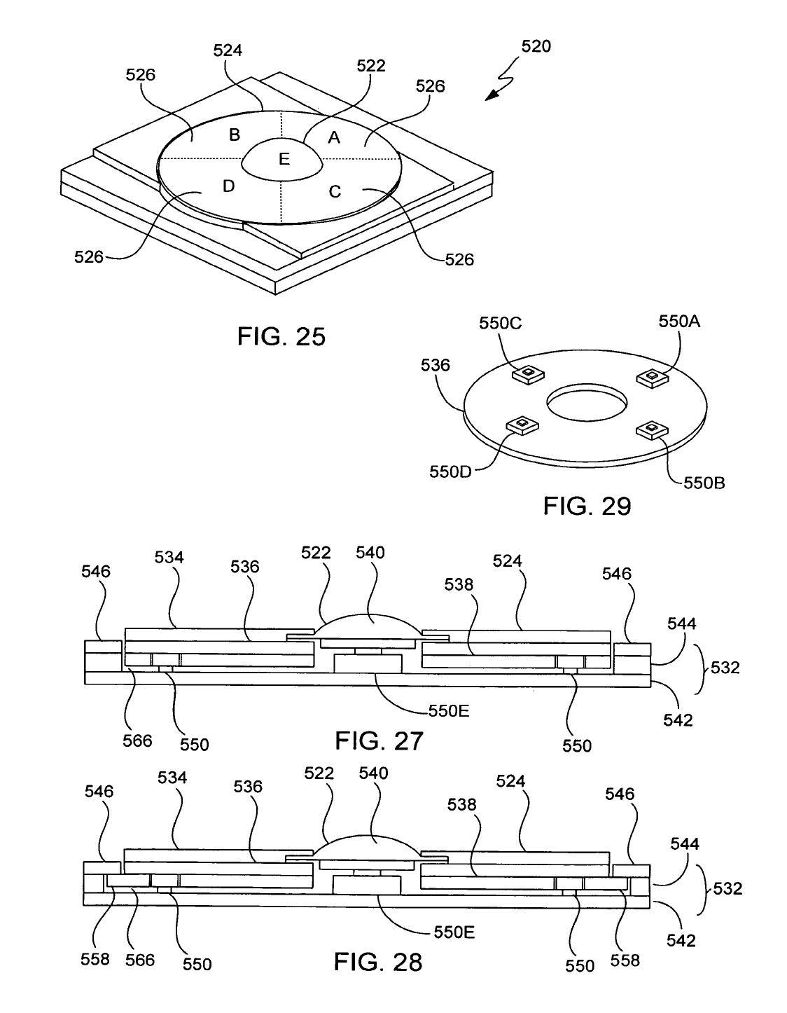

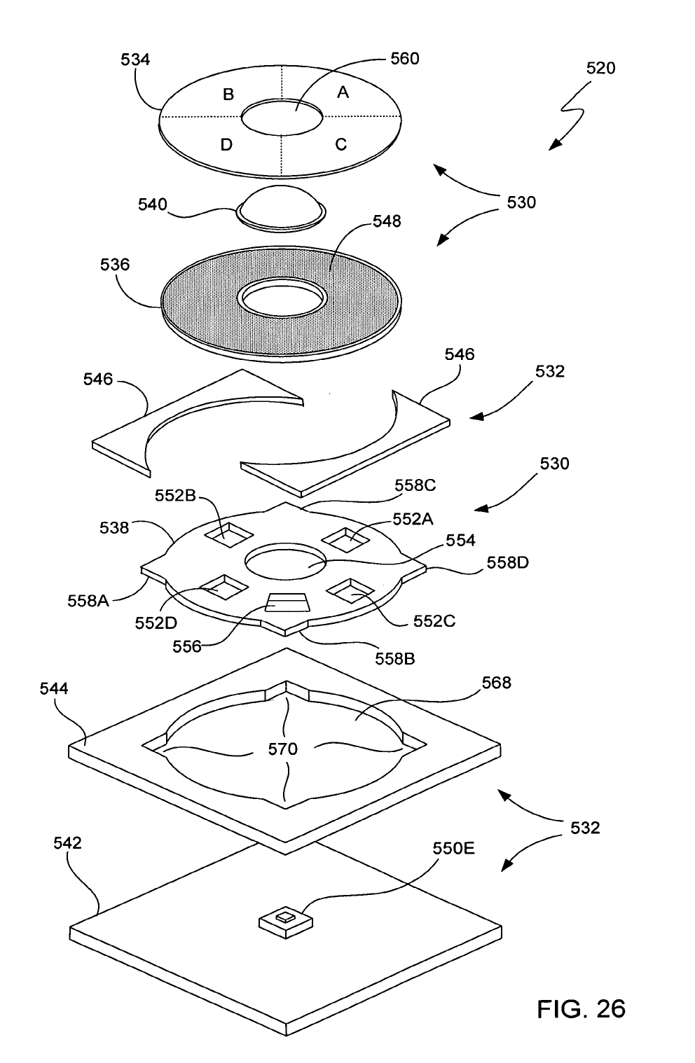

FIGS. 25-28 are diagrams of an input device 520, in accordance with one embodiment of the present invention. FIG. 25 is a perspective view of an assembled input device 520 and FIG. 26 is an exploded perspective view of a disassembled input device 520. FIGS. 27 and 28 are side elevation views, in cross section, of the input device 520 in its assembled condition (taken along lines 10-10′ and 11-11′ respectively). By way of example, the input device 520 may generally correspond to the input device described in FIGS. 22-24D. Unlike the input device of FIGS. 22-24D, however, the input device 520 shown in these figures includes a separate mechanical button 522 disposed at the center of the touch pad 524 having four button zones 526A-D. The separate mechanical button 522 further increases the button functionality of the input device 520 (e.g., from four to five).

Referring to FIGS. 26-28, the input device 520 includes a circular touch pad assembly 530 and a housing 532. The circular touch pad assembly 530 is formed by a cosmetic disc 534, circuit board 536, stiffener plate 538 and button cap 540. The circuit board 536 includes an electrode layer 548 on the top side and four mechanical switches 550 on the backside (see FIG. 29). The switches 550 may be widely varied. Generally, they may correspond to tact switches. More particularly, they correspond to packaged or encased SMT mounted dome switches. By way of example, dome switches manufactured by ALPS of Japan may be used. Although not shown, the backside of the circuit board 536 also includes support circuitry for the touch pad (e.g., ASIC, connector, etc.). The cosmetic disc 534, which is attached to the top side of the circuit board 536 is configured to protect the electrode layer 548 located thereon. The cosmetic disc 534 may be formed from any suitable material although it is typically formed from a non-conducting material when capacitance sensing is used. By way of example, the cosmetic disc may be formed from plastic, glass, wood and the like. Furthermore, the cosmetic disc 534 may be attached to the circuit board 536 using any suitable attachment means, including but not limited to adhesives, glue, snaps, screws and the like. In one embodiment, double sided tape is positioned between the circuit board 536 and the cosmetic disc 534 in order to attach the cosmetic disc 534 to the circuit board 536.

The stiffener plate 538, which is attached to the back side of the circuit board 536, is configured to add stiffness to the circuit board 536. As should be appreciated, circuit boards typically have a certain amount of flex. The stiffener plate 538 reduces the amount of flex so as to form a rigid structure. The stiffener plate 538 includes a plurality of holes. Some of the holes 552 are configured to receive the four mechanical switches 550 therethrough while other holes such as holes 554 and 556 may be used for component clearance (or other switches). The stiffener plate 538 also includes a plurality of ears 558 extending from the outer peripheral edge of the stiffener plate 538. The ears 558 are configured to establish the axes around which the touch pad assembly 530 pivots in order to form a clicking action for each of the button zones 526A-526D as well as to retain the touch pad assembly 530 within the housing 532. The stiffener plate may be formed from any rigid material. For example, the stiffener plate may be formed from steel, plastic and the like. In some cases, the steel may be coated. Furthermore, the stiffener plate 538 may be attached to the circuit board 536 using any suitable attachment means, including but not limited to adhesives, glue, snaps, screws and the like. In one embodiment, double sided tape is positioned between the circuit board 536 and the stiffener plate 538 in order to attach the stiffener plate 538 to the circuit board 536.

Furthermore, the button cap 540 is disposed between the cosmetic disc 534 and the top side of the circuit board 536. A portion of the button cap 540 is configured to protrude through an opening 560 in the cosmetic disc 534 while another portion is retained in a space formed between the cosmetic disc 534 and the top surface of the circuit board 534 (see FIGS. 27 and 28). The protruding portion of the button cap 540 may be pushed to activate a switch 550E located underneath the button cap 540. The switch 550E is attached to the housing 532 and passes through openings in the stiffener plate 538, circuit board 536 and cosmetic disc 534. When assembled, the actuator of the switch 550E via a spring element forces the button cap 540 into an upright position as shown in FIGS. 27 and 28.

The housing 532, on the other hand, is formed by a base plate 542, a frame 544 and a pair of retainer plates 546. When assembled, the retaining plates 546, base plate 542 and frame 544 define a space 566 for movably restraining the stiffener plate 538 to the housing 532. The frame 544 includes an opening 568 for receiving the stiffener plate 538. As shown, the shape of the opening 568 matches the shape of the stiffener plate 538. In fact, the opening 568 includes alignment notches 570 for receiving the ears 558 of the stiffener plate 538. The alignment notches 570 cooperate with the ears 558 to locate the touch pad assembly 530 in the x and y plane, prevent rotation about the z axis, and to establish pivot areas for forming the clicking actions associated with each of the button zones 524A-524D. The base plate 542 closes up the bottom of the opening 568 and the corners of the retaining plates 546 are positioned over the ears 558 and alignment notches 570 thereby retaining the stiffener plate 538 within the space 566 of the housing 532.

As shown in FIGS. 27 and 28, the frame 544 is attached to the base plate 542 and the retaining plates 546 are attached to the frame 544. Any suitable attachment means may be used including but not limited to glues, adhesives, snaps, screws and the like. In one embodiment, the retaining plates 546 are attached to the frame 544 via double sided tape, and the frame 544 is attached to the base plate 542 via screws located at the corners of the frame/base plate. The parts of the housing 532 may be formed from a variety of structural materials such as metals, plastics and the like.

In the configuration illustrated in FIGS. 25-29, when a user presses down on a button zone 526, the ears 558 on the other side of the button zone 526, which are contained within the alignment notches 570, are pinned against the retaining plates 546. When pinned, the contact point between the ears 558 and the retaining plates 546 define the axis around which the touch pad assembly 530 pivots relative to the housing 532. By way of example, ears 558A and 558B establish the axis for button zone 526A, ears 558C and 558D establish the axis for button zone 526D, ears 558A and 558C establish the axis for button zone 526C, and ears 558B and 558D establish the axis for button zone 526D. To further illustrate, when a user presses on button zone 526A, the touch pad assembly 530 moves downward in the area of button zone 526A. When button zone 526A moves downward against the spring force of the switch 550A, the opposing ears 558A and 558B are pinned against the corners of retaining plates 546.

Although not shown, the touch pad assembly 530 may be back lit in some cases. For example, the circuit board can be populated with light emitting diodes (LEDs) on either side in order to designate button zones, provide additional feedback and the like.

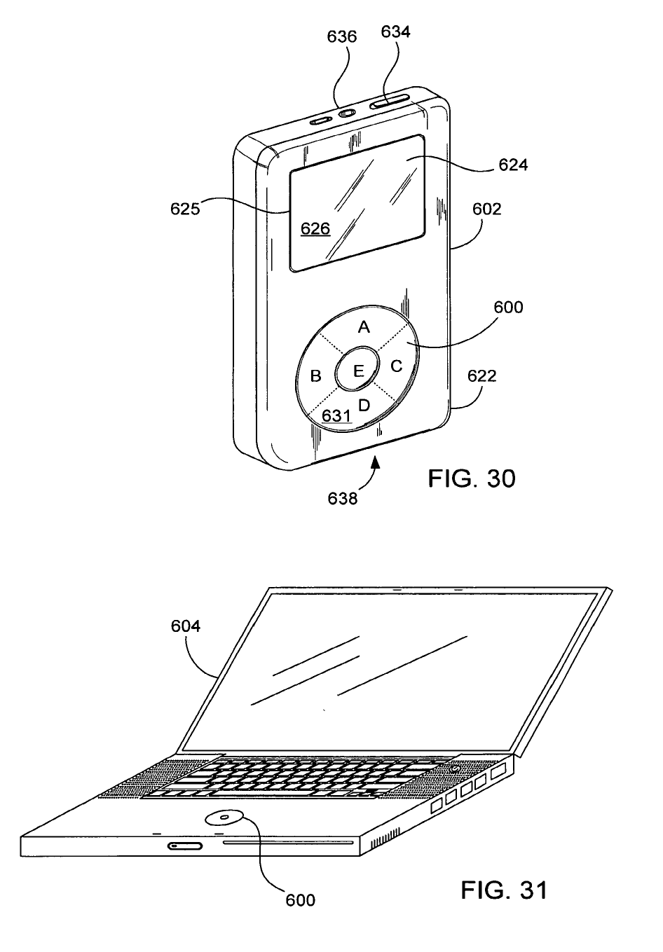

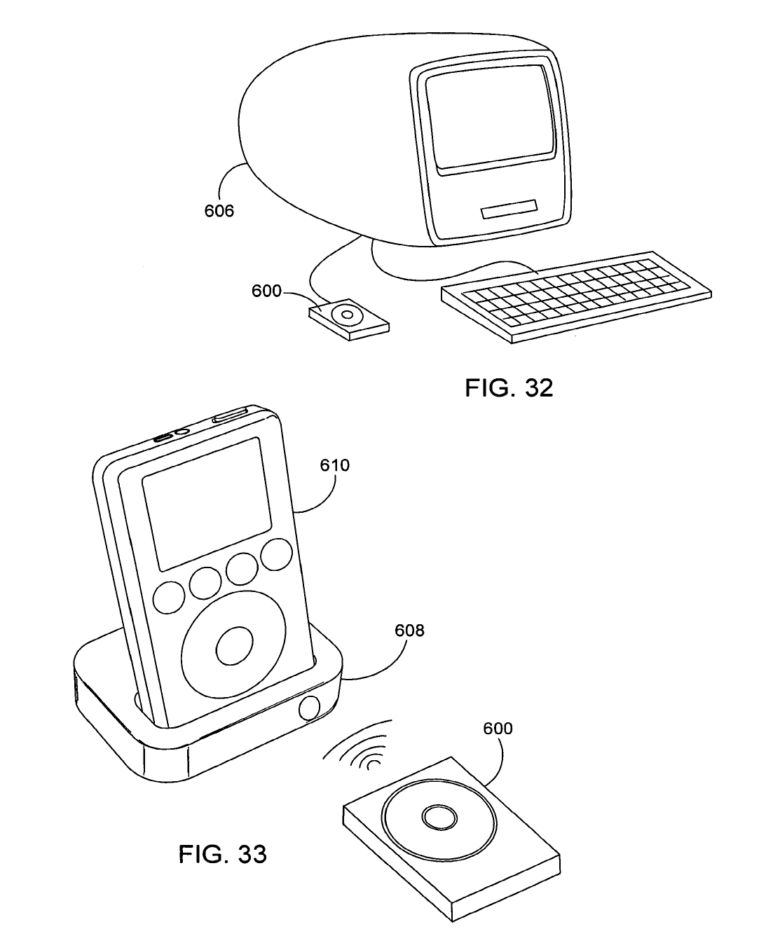

As previously mentioned, the input devices described herein may be integrated into an electronic device or they may be separate stand alone devices. FIGS. 30 and 31 show some implementations of an input device 600 integrated into an electronic device. In FIG. 30, the input device 600 is incorporated into a media player 602. In FIG. 31, the input device 600 is incorporated into a laptop computer 604. FIGS. 32 and 33, on the other hand, show some implementations of the input device 600 as a stand alone unit. In FIG. 32, the input device 600 is a peripheral device that is connected to a desktop computer 606. In FIG. 33, the input device 600 is a remote control that wirelessly connects to a docking station 608 with a media player 610 docked therein. It should be noted, however, that the remote control can also be configured to interact with the media player (or other electronic device) directly thereby eliminating the need for a docking station. An example of a docking station for a media player can be found in U.S. patent application Ser. No. 10/423,490, entitled “MEDIA PLAYER SYSTEM,” filed Apr. 25, 2003, which is hereby incorporated by reference. It should be noted that these particular embodiments are not a limitation and that many other devices and configurations may be used.

Referring back to FIG. 30, the media player 602 will be discussed in greater detail. The term “media player” generally refers to computing devices that are dedicated to processing media such as audio, video or other images, as for example, music players, game players, video players, video recorders, cameras, and the like. In some cases, the media players contain single functionality (e.g., a media player dedicated to playing music) and in other cases the media players contain multiple functionality (e.g., a media player that plays music, displays video, stores pictures and the like). In either case, these devices are generally portable so as to allow a user to listen to music, play games or video, record video or take pictures wherever the user travels.

In one embodiment, the media player is a handheld device that is sized for placement into a pocket of the user. By being pocket sized, the user does not have to directly carry the device and therefore the device can be taken almost anywhere the user travels (e.g., the user is not limited by carrying a large, bulky and often heavy device, as in a laptop or notebook computer). For example, in the case of a music player, a user may use the device while working out at the gym. In case of a camera, a user may use the device while mountain climbing. In the case of a game player, the user can use the device while traveling in a car. Furthermore, the device may be operated by the user's hands, no reference surface such as a desktop is needed. In the illustrated embodiment, the media player 602 is a pocket sized hand held MP3 music player that allows a user to store a large collection of music (e.g., in some cases up to 4,000 CD-quality songs). By way of example, the MP3 music player may correspond to the iPod® brand MP3 player manufactured by Apple Computer, Inc. of Cupertino, Calif. Although used primarily for storing and playing music, the MP3 music player shown herein may also include additional functionality such as storing a calendar and phone lists, storing and playing games, storing photos and the like. In fact, in some cases, it may act as a highly transportable storage device.

As shown in FIG. 30, the media player 602 includes a housing 622 that encloses internally various electrical components (including integrated circuit chips and other circuitry) to provide computing operations for the media player 602. In addition, the housing 622 may also define the shape or form of the media player 602. That is, the contour of the housing 622 may embody the outward physical appearance of the media player 602. The integrated circuit chips and other circuitry contained within the housing 622 may include a microprocessor (e.g., CPU), memory (e.g., ROM, RAM), a power supply (e.g., battery), a circuit board, a hard drive, other memory (e.g., flash) and/or various input/output (I/O) support circuitry. The electrical components may also include components for inputting or outputting music or sound such as a microphone, amplifier and a digital signal processor (DSP). The electrical components may also include components for capturing images such as image sensors (e.g., charge coupled device (CCD) or complimentary oxide semiconductor (CMOS)) or optics (e.g., lenses, splitters, filters).

In the illustrated embodiment, the media player 602 includes a hard drive thereby giving the media player massive storage capacity. For example, a 20 GB hard drive can store up to 4000 songs or about 266 hours of music. In contrast, flash-based media players on average store up to 128 MB, or about two hours, of music. The hard drive capacity may be widely varied (e.g., 5, 10, 20 GB, etc.). In addition to the hard drive, the media player 602 shown herein also includes a battery such as a rechargeable lithium polymer battery. These types of batteries are capable of offering about 10 hours of continuous playtime to the media player.

The media player 602 also includes a display screen 624 and related circuitry. The display screen 624 is used to display a graphical user interface as well as other information to the user (e.g., text, objects, graphics). By way of example, the display screen 624 may be a liquid crystal display (LCD). In one particular embodiment, the display screen corresponds to a 160-by-128-pixel high-resolution display, with a white LED backlight to give clear visibility in daylight as well as low-light conditions. As shown, the display screen 624 is visible to a user of the media player 602 through an opening 625 in the housing 622, and through a transparent wall 626 that is disposed in front of the opening 625. Although transparent, the transparent wall 626 may be considered part of the housing 622 since it helps to define the shape or form of the media player 602.

The media player 602 also includes the touch pad 600 such as any of those previously described. The touch pad 600 generally consists of a touchable outer surface 631 for receiving a finger for manipulation on the touch pad 630. Although not shown in FIG. 30, beneath the touchable outer surface 631 is a sensor arrangement. The sensor arrangement includes a plurality of sensors that are configured to activate as the finger sits on, taps on or passes over them. In the simplest case, an electrical signal is produced each time the finger is positioned over a sensor. The number of signals in a given time frame may indicate location, direction, speed and acceleration of the finger on the touch pad, i.e., the more signals, the more the user moved his or her finger. In most cases, the signals are monitored by an electronic interface that converts the number, combination and frequency of the signals into location, direction, speed and acceleration information. This information may then be used by the media player 602 to perform the desired control function on the display screen 624. For example, a user may easily scroll through a list of songs by swirling the finger around the touch pad 600.

In addition to above, the touch pad may also include one or more movable buttons zones A-D as well as a center button E. The button zones are configured to provide one or more dedicated control functions for making selections or issuing commands associated with operating the media player 602. By way of example, in the case of an MP3 music player, the button functions may be associated with opening a menu, playing a song, fast forwarding a song, seeking through a menu, making selections and the like. In most cases, the button functions are implemented via a mechanical clicking action.

The position of the touch pad 600 relative to the housing 622 may be widely varied. For example, the touch pad 600 may be placed at any external surface (e.g., top, side, front, or back) of the housing 622 that is accessible to a user during manipulation of the media player 602. In most cases, the touch sensitive surface 631 of the touch pad 600 is completely exposed to the user. In the embodiment illustrated in FIG. 30, the touch pad 600 is located in a lower, front area of the housing 622. Furthermore, the touch pad 600 may be recessed below, level with, or extend above the surface of the housing 622. In the embodiment illustrated in FIG. 30, the touch sensitive surface 631 of the touch pad 600 is substantially flush with the external surface of the housing 622.

The shape of the touch pad 600 may also be widely varied. Although shown as circular, the touch pad may also be square, rectangular, triangular, and the like. More particularly, the touch pad is annular, i.e., shaped like or forming a ring. As such, the inner and outer perimeter of the touch pad defines the working boundary of the touch pad.

The media player 602 may also include a hold switch 634. The hold switch 634 is configured to activate or deactivate the touch pad and/or buttons associated therewith. This is generally done to prevent unwanted commands by the touch pad and/or buttons, as for example, when the media player is stored inside a user's pocket. When deactivated, signals from the buttons and/or touch pad are not sent or are disregarded by the media player. When activated, signals from the buttons and/or touch pad are sent and therefore received and processed by the media player.

Moreover, the media player 602 may also include one or more headphone jacks 636 and one or more data ports 638. The headphone jack 636 is capable of receiving a headphone connector associated with headphones configured for listening to sound being outputted by the media device 602. The data port 638, on the other hand, is capable of receiving a data connector/cable assembly configured for transmitting and receiving data to and from a host device such as a general purpose computer (e.g., desktop computer, portable computer). By way of example, the data port 638 may be used to upload or down load audio, video and other images to and from the media device 602. For example, the data port may be used to download songs and play lists, audio books, ebooks, photos, and the like into the storage mechanism of the media player.

The data port 638 may be widely varied. For example, the data port may be a PS/2 port, a serial port, a parallel port, a USB port, a Firewire port and/or the like. In some cases, the data port 638 may be a radio frequency (RF) link or optical infrared (IR) link to eliminate the need for a cable. Although not shown in FIG. 30, the media player 602 may also include a power port that receives a power connector/cable assembly configured for delivering powering to the media player 602. In some cases, the data port 638 may serve as both a data and power port. In the illustrated embodiment, the data port 638 is a Firewire port having both data and power capabilities.

Although only one data port is shown, it should be noted that this is not a limitation and that multiple data ports may be incorporated into the media player. In a similar vein, the data port may include multiple data functionality, i.e., integrating the functionality of multiple data ports into a single data port. Furthermore, it should be noted that the position of the hold switch, headphone jack and data port on the housing may be widely varied. That is, they are not limited to the positions shown in FIG. 30. They may be positioned almost anywhere on the housing (e.g., front, back, sides, top, bottom). For example, the data port may be positioned on the bottom surface of the housing rather than the top surface as shown.

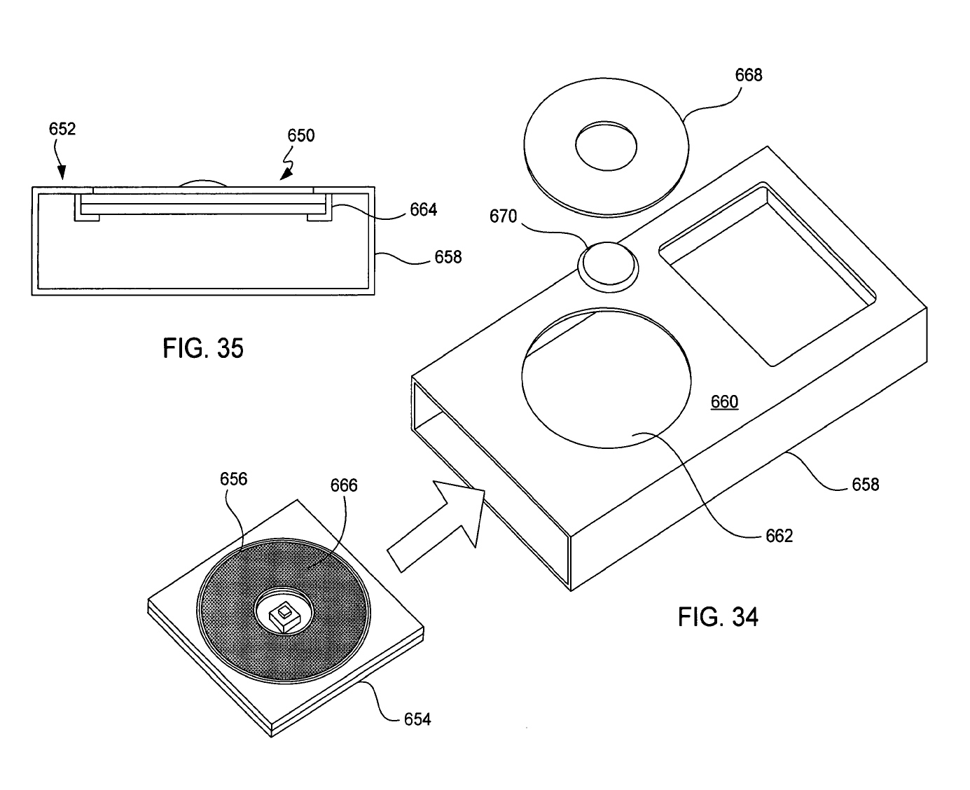

FIGS. 34 and 35 are diagrams showing the installation of an input device 650 into a media player 652, in accordance with one embodiment of the present invention. By way of example, the input device 650 may correspond to any of those previously described and the media player 652 may correspond to the one shown in FIG. 30. As shown, the input device 650 includes a housing 654 and a touch pad assembly 656. The media player 652 includes a shell or enclosure 658. The front wall 660 of the shell 658 includes an opening 662 for allowing access to the touch pad assembly 656 when the input device 650 is introduced into the media player 652. The inner side of the front wall 660 includes a channel or track 664 for receiving the input device 650 inside the shell 658 of the media player 652. The channel 664 is configured to receive the edges of the housing 654 of the input device 650 so that the input device 650 can be slid into its desired place within the shell 658. The shape of the channel has a shape that generally coincides with the shape of the housing 654. During assembly, the circuit board 666 of the touch pad assembly 656 is aligned with the opening 662 and a cosmetic disc 668 and button cap 670 are mounted onto the top side of the circuit board 666. As shown, the cosmetic disc 668 has a shape that generally coincides with the opening 662. The input device may be held within the channel via a retaining mechanism such as screws, snaps, adhesives, press fit mechanisms, crush ribs and the like.

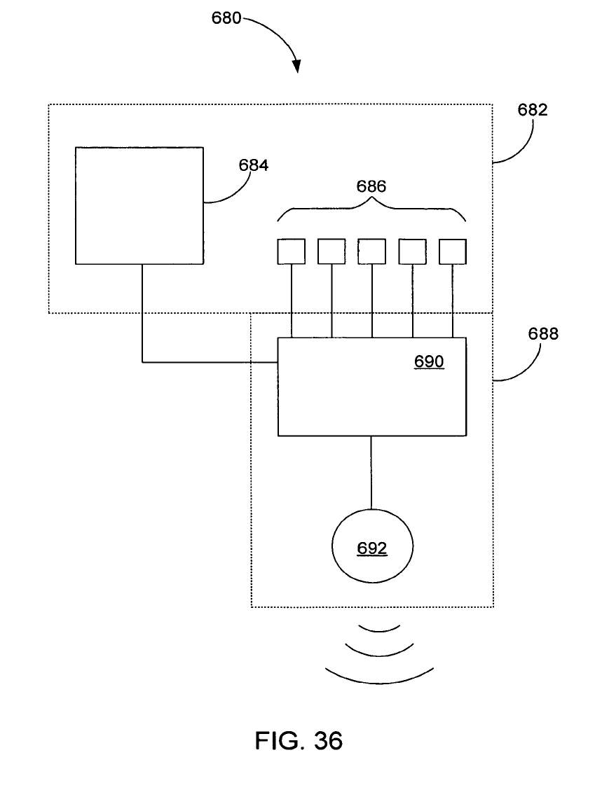

FIG. 36 is a simplified block diagram of a remote control 680 incorporating an input device 682 therein, in accordance with one embodiment of the present invention. By way of example, the input device 682 may correspond to any of the previously described input devices. In this particular embodiment, the input device 682 corresponds to the input device shown in FIGS. 24A-28, thus the input device includes a touch pad 684 and a plurality of switches 686. The touch pad 684 and switches 686 are operatively coupled to a wireless transmitter 688. The wireless transmitter 688 is configured to transmit information over a wireless communication link so that an electronic device having receiving capabilities may receive the information over the wireless communication link. The wireless transmitter 688 may be widely varied. For example, it may be based on wireless technologies such as FM, RF, Bluetooth, 802.11 UWB (ultra wide band), IR, magnetic link (induction) and/or the like. In the illustrated embodiment, the wireless transmitter 688 is based on IR. IR generally refers wireless technologies that convey data through infrared radiation. As such, the wireless transmitter 688 generally includes an IR controller 690. The IR controller 690 takes the information reported from the touch pad 684 and switches 686 and converts this information into infrared radiation as for example using a light emitting diode 692.

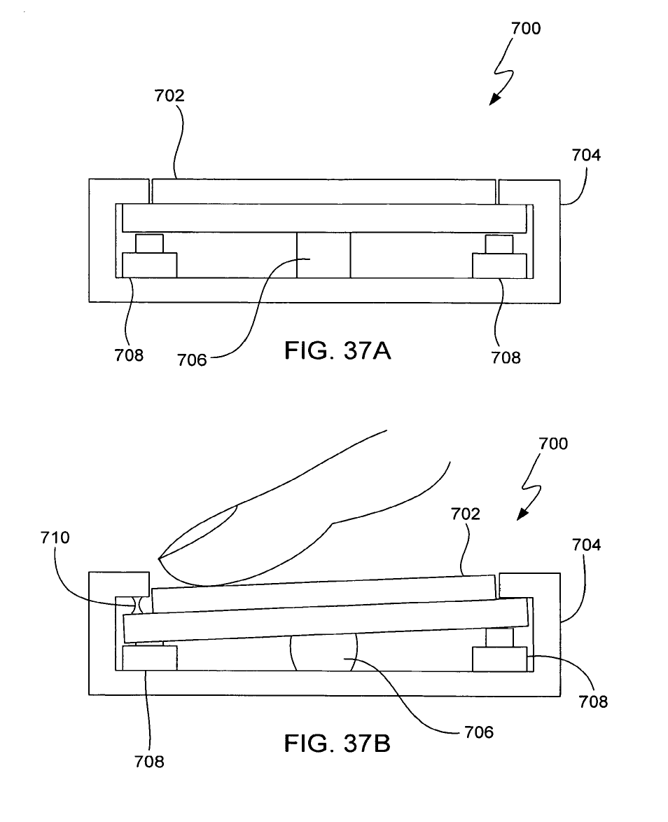

FIGS. 37A and 37B are diagrams of an input device 700, in accordance with an alternate embodiment of the present invention. This embodiment is similar to those shown in FIGS. 22-29, however instead of relying on a spring component of a switch, the input device 700 utilizes a separate spring component 706. As shown, the input device 700 includes a touch pad 702 containing all of its various layers. The touch pad 702 is coupled to a frame 704 or housing of the input device 700 via the spring component 706. The spring component 706 (or flexure) allows the touch pad 702 to pivot in multiple directions when a force is applied to the touch pad 702 thereby allowing a plurality of button zones to be created. The spring component 706 also urges the touch pad 702 into an upright position similar to the previous embodiments. When the touch pad 702 is depressed at a particular button zone (overcoming the spring force), the touch pad 702 moves into contact with a switch 708 positioned underneath the button zone of the touch pad 702. Upon contact, the switch 708 generates a button signal. The switch 708 may be attached to the touch pad 702 or the housing 704. In this embodiment, the switch 708 is attached to the housing 702. In some cases, a seal 710 may be provided to eliminate crack and gaps found between the touch pad 702 and the housing 704. The spring component 706 may be widely varied. For example, it may be formed from one or more conventional springs, pistons, magnets or compliant members. In the illustrated embodiment, the spring component 706 takes the form of a compliant bumper formed from rubber or foam.

While this invention has been described in terms of several preferred embodiments, there are alterations, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. (canceled)

2. A portable electronic device comprising:
a display,
a rotatable input element enabling generation of first input signals in response to rotation of the rotatable input element, and
a circular touch-sensitive element associated with the display, the circular touch-sensitive element enabling generation of second input signals when an object touches or moves across a surface of the circular touch-sensitive element.

3. The portable electronic device of claim 2, wherein the rotatable input element comprises an annular element.

4. The portable electronic device of claim 2, wherein at least a portion of the rotatable input element is disposed in a channel formed in the device.

5. The portable electronic device of claim 4, wherein the rotatable input element is configured to slide relative to the channel during rotation of the rotatable input element.

6. The portable electronic device of claim 2, wherein the first input signals are generated by at least one of a switch and an encoder.

7. The portable electronic device of claim 2, wherein receipt of the first input signals enables at least one of a scrolling function and a zooming function.

8. The portable device of claim 7, wherein the scrolling function comprises scrolling through a list.

9. The portable electronic device of claim 2, wherein the circular touch sensitive element is configured to flex relative to the device, the circular touch-sensitive element enabling generation of third input signals when the circular touch-sensitive element flexes.

10. The portable electronic device of claim 9, wherein multiple device functions are selectively enabled by sequential receipt of at least two of the first, second, and third input signals.

11. The portable device of claim 10, wherein the multiple device functions comprise at least a scrolling function and a zooming function.

12. The portable device of claim 11, wherein the scrolling function comprises scrolling through a list.

13. The portable electronic device of claim 2 comprising a wireless transmitter.

14. The portable electronic device of claim 13, wherein the wireless transmitter enables cellular communication.

15. A portable electronic device comprising:
a display,
a rotatable ring that enables generation of first input signals in response to rotation of the ring, and
a circular touch-sensitive element associated with the display, the circular touch-sensitive element enabling generation of second input signals when an object touches or moves across a surface of the circular touch-sensitive element.
